(19) United States
(12) Patent Application Publication
(10) Pub. No.: US 2015/0018458 A1
(43) Pub. Date: Jan. 15, 2015

(54) METHOD OF PACKAGING GRANULAR ENCAPSULATING RESIN COMPOSITION, PACKAGE AND METHOD OF TRANSPORTING PACKAGE

(71) Applicant: SUMITOMO BAKELITE CO., LTD., Tokyo (JP)

(72) Inventor: Yusuke Ito, Fukuoka (JP)

(21) Appl. No.: 14/371,140

(22) PCT Filed: Feb. 26, 2013
(86) PCT No.: PCT/JP2013/001093

§ 371 Date: Jul. 8, 2014

(30) Foreign Application Priority Data
Feb. 29, 2012 (JP) 2012-044268

(51) Int. Cl. C08L 63/00

(52) U.S. Cl. CPC C08L 63/00
USPC 523/456; 53/396

(57) ABSTRACT

The present invention provides a technique for suppressing the consolidation a portion of a granular encapsulating resin composition which may occur after accommodating the granular encapsulating resin composition in a packaging material. Provided is a method of packaging a granular encapsulating resin composition, in which, when the bulk density of the granular encapsulating resin composition is M (g/cc) and the height of the deposited material of the granular encapsulating resin composition is L (cm) in a state of being accommodated in the packaging material, the method satisfies the relationship M×L≦19.

### TECHNICAL FIELD

The present invention relates to a method of packaging an encapsulating resin composition, a package and a method of transporting a package.

### BACKGROUND ART

In Patent Document 1, an invention relating to a method of packaging an epoxy resin molding material for semiconductor encapsulation used for encapsulating a semiconductor element is disclosed. In the invention, in order to prevent moisture absorption by the epoxy resin molding material for semiconductor encapsulation in a packaged state, a desiccant is placed and encapsulated in the same bag as the epoxy resin molding material for semiconductor encapsulation.

### RELATED DOCUMENT

### Patent Document

[Patent Document 1] Japanese Unexamined Patent Publication No. 2004-90971

### DISCLOSURE OF THE INVENTION

The inventor discovered the following problems in a granular encapsulating resin composition used for encapsulating electronic components such as semiconductor elements, transistors, thyristors, diodes, solid-state imaging elements, capacitors, resistors, and LEDs.

In the related art, for example, after an encapsulating resin composition is accommodated in an inner packaging material such as a bag, one or a plurality of inner packaging materials is accommodated in one outer packaging material formed from a metal can or a cardboard box, and stored and transported in this state. These packaging materials are unsealed when used, and the granular encapsulating resin composition is removed.

In the case of a granular encapsulating resin composition, during a period from after being accommodated in the packaging material until being removed from the packaging material for use, there are cases in which a portion of the granular encapsulating resin composition consolidates, and becomes agglomerated, or cases in which a state of the granular encapsulating resin composition potentially easily becoming agglomerated (that is, a state of becoming agglomerated by a transfer process described later) occurs. For such agglomerates, for example, there is concern of defects occurring in the process of supplying the granular encapsulating resin composition removed from the packaging material to a predetermined location in a molding machine, transferring the resin composition to a feeder or the like, transferring the resin composition from the feeder to a resin material supply vessel, and weighing the granular encapsulating resin composition, thus hindering smooth automatic molding when compression molding a semiconductor element. During compression molding, when agglomerates are present in the granular composition placed on a die, there is concern of only that portion transferring heat slowly, mold clamping being performed with the granular encapsulating resin composition incompletely melted, causing the risk of deformed wires and incomplete filling.

The present invention addresses the problem of suppressing the consolidation of a portion of a granular encapsulating resin composition which may occur after the granular encapsulating resin composition is accommodated in a packaging material.

According to the invention, there is provided a method of packaging a granular encapsulating resin composition, in which, when a bulk density of the granular encapsulating resin composition is M (g/cc), and a height of a deposited material of the granular encapsulating resin composition is L (cm) in the state of the granular encapsulating resin composition being accommodated in the packaging material, the method satisfies the relationship M×L≦19.

According to the invention, there is provided a package including a packaging material, and a granular encapsulating resin composition with a bulk density of M (g/cc) that is accommodated in the packaging material, in which, when the height of deposited material of the granular encapsulating resin composition is L (cm) in a state of the granular encapsulating resin composition being accommodated in the packaging material, the relationship M×L≦19 is satisfied.

According to the invention, there is provided a transport method of transporting a granular encapsulating resin composition in a state of being accommodated in a packaging material, in which, when a bulk density of the granular encapsulating resin composition is set to M (g/cc), and a height of deposited material of the granular encapsulating resin composition is L (cm) in a state of being accommodated in the packaging material, the method satisfies the relationship M×L≦19.

In the invention, the term “granular” means powder-like, and including fine particles is allowable as long as the effects of the invention are exhibited.

According to the invention it is possible to suppress the consolidation of a portion of a granular encapsulating resin composition which may occur after the granular encapsulating resin composition is accommodated in a packaging material.

### BRIEF DESCRIPTION OF THE DRAWINGS

The above-described object, and other objects, characteristics and advantages are further clarified through the preferred embodiments described below and the attendant drawings below.

FIG. 1 is a cross-sectional view schematically showing an example of a state in which an encapsulating resin composition is packaged with the packaging method of the embodiment.

FIG. 2 is a perspective view schematically showing an example of an outer packaging material of the embodiment.

FIG. 3 is a perspective view schematically showing an example of the outer packaging material of the embodiment.

FIG. 4 is a perspective view schematically showing an example of the outer packaging material of the embodiment.

FIG. 5 is a schematic view of an example from transferring to weighing in a method in which a semiconductor device is obtained by encapsulating a semiconductor element through compression molding using an encapsulating epoxy resin composition of the embodiment.

FIG. 6 is a schematic view of an example of a supply method to a lower die cavity of a die in a method in which a semiconductor device is obtained by encapsulating a semiconductor element through compression molding using an encapsulating epoxy resin composition of the embodiment.

FIG. 7 is a diagram showing a cross-sectional structure of an example of a semiconductor device obtained by encapsulating a semiconductor element mounted on a lead frame using an encapsulating epoxy resin composition according to the embodiment.

FIG. 8 is a diagram showing a cross-sectional structure of an example of a semiconductor device obtained by encapsulating a semiconductor element mounted on a circuit substrate using an encapsulating epoxy resin composition according to the embodiment.

### DESCRIPTION OF EMBODIMENTS

Hereinafter, embodiments of the invention are described with reference to the drawings. In all of the drawings, like constituent elements are given like references, and description will not be repeated.

The present embodiment is a method of packaging an encapsulating resin composition. According to the characteristics thereof, defects of a portion of the granular encapsulating resin composition consolidating after the granular encapsulating resin composition is accommodated in the packaging material until removed from the packaging material for use (below, referred to as “during storage”) are suppressed.

### First Embodiment

### Outline of Present Embodiment

First, an outline of the embodiment will be described.

The inventor considered a case in which the granular encapsulating resin composition was stored in a state of the granular encapsulating resin being pushed against each other with a predetermined force or higher, and the granular encapsulating resin composition consolidated.

Attention was paid to the force caused by the weight of the granular encapsulating resin composition accommodated in the upper side applied to the granular encapsulating resin composition accommodated in the lower side of the packaging material. For example, in a case in which a large amount of the granular encapsulating resin composition is accommodated in one inner packaging material (bag) so as to amass in the height direction, a force caused by the weight of the granular encapsulating resin composition positioned on the upper side of the packaging material is applied to the granular encapsulating resin composition positioned on the lower side of the packaging material. In a case of a plurality of inner packaging materials being stacked in one outer packaging material (cardboard box or the like), force caused by the weight of the granular encapsulating resin composition accommodated in the inner packaging material positioned on the upper side is applied to the granular encapsulating resin composition accommodated in the inner packaging material positioned on the lower side.

The inventor considered that because there are cases in which the force applied to the granular encapsulating resin composition accommodated on the lower side caused by the weight of the granular encapsulating resin composition accommodated on the upper side of such a packaging material (below, referred to as “force of its own weight”) exceeds the predetermined force or higher, defects occur during storage in which a portion of the granular encapsulating resin composition consolidates. The inventor discovered that it is possible to suppress defects in which a portion of the granular encapsulating resin composition consolidates during storage by controlling the maximum value of the force of its own weight applied to the granular encapsulating resin composition during storage, more specifically, the maximum value of the force of its own weight applied to the granular encapsulating resin composition positioned on the lower side.

### Overview of Present Embodiment

Next, an overview of the embodiment realized based on the outline will be described.

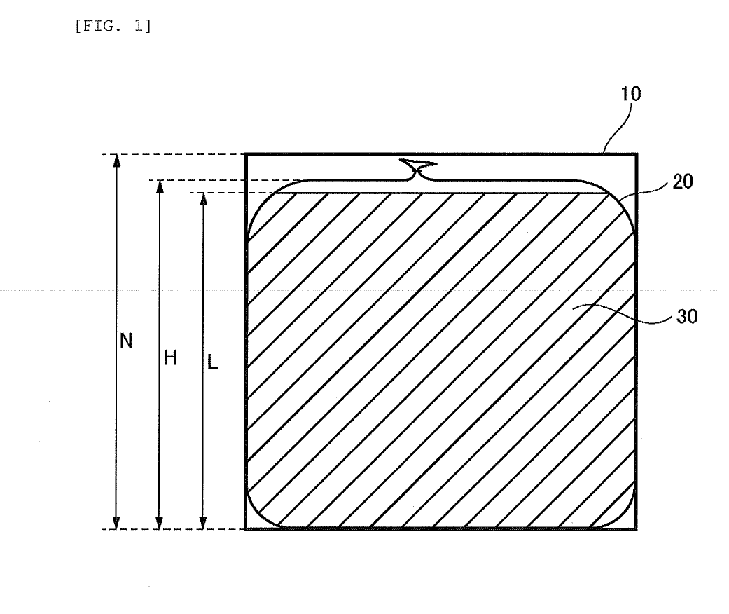

FIG. 1 shows an example of a cross-sectional schematic view showing the granular encapsulating resin composition in a state of being packaged with the packaging method of the embodiment. As shown in FIG. 1, in the embodiment, the granular encapsulating resin composition 30 is accommodated in the inner packaging material 20, and the inner packaging material 20 after being sealed is accommodated in the outer packaging material 10. The relationship M×L≦19 is satisfied when the bulk density of the granular encapsulating resin composition 30 is M (g/cc), and the height of the deposited material of the granular encapsulating resin composition 30 is L (cm) in a state of being accommodated in the packaging material. The inventor discovered that defects of a portion of the granular encapsulating resin composition 30 consolidating during storage are suppressed in a case in which the granular encapsulating resin composition 30 described below is packaged so as to satisfy the conditions.

In a case in which the height of the inner packaging material 20 in a state of being accommodated in the outer packaging material 10 is H (cm), the relationship M×H≦19 may be satisfied. Since the relationship L≦H is certainly satisfied, M×L≦19 is also certainly satisfied in a case in which M×H≦19 is satisfied.

Furthermore, in a case in which the height of the space that accommodates the inner packaging material 20 formed by the outer packaging material 10 is N (cm), the relationship N×H≦19 may be satisfied. Since the relationship L≦N is certainly satisfied, M×L≦19 is also certainly satisfied in a case in which M×N≦19 is satisfied.

In the embodiment, the granular encapsulating resin composition 30 is stored and transported in this state. In the example shown in FIG. 1, one inner packaging material 20 is accommodated in one outer packaging material 10. A plurality of inner packaging materials 20 are able to be accommodated in one outer packaging material 10, and an example will be described as below.

### Configuration of Present Embodiment

Below, the configuration of the embodiment will be described in detail.

### <Encapsulating Resin Composition 30>

The granular encapsulating resin composition 30 is used for encapsulating electronic components, such as semiconductor elements, transistors, thyristors, diodes, solid-state imaging elements, capacitors, resistors, and LEDs. The granular encapsulating resin composition 30 may include one or more of (a) an epoxy resin, (b) a curing agent, (c) an inorganic filler, (d) a curing accelerator, and (e) a coupling agent. Also, the granular encapsulating resin composition 30 is in a granular state. Although the form of distribution differs according to the preparation method, preparation conditions or the like, for example, it is possible to control the bulk density to equal to or more than 0.70 g/cc and equal to or less than 0.95 g/cc, or to equal to or more than 1.0 g/cc and equal to or less than 1.3 g/cc. For the particle size of the granular encapsulating resin composition 30 of the embodiment, the proportion of particles of equal to or more than 2 mm is preferably equal to or less than 3 mass %, and fine powder of less than 106 μm in particle size are preferably included at a proportion of equal to or less than 5 mass % of the granular encapsulating resin composition in the particle size distribution measured by sieving using a JIS standard sieve.

The bulk density here is a value measured by the method below. Using a powder tester (manufactured by Hosokawa Micron), after a sample of the granular encapsulating resin composition 30 was slowly placed in a measuring vessel with an inner radius of 50.46 mm, a depth of 50 mm and a volume of 100 cm³ with a cylinder attached to the upper portion, tapping was performed 180 times, and thereafter, the upper cylinder was removed, the sample deposited on the upper portion of the measuring vessel was leveled with a blade, and the weight of the sample charged to the measuring vessel was measured.

Next, each composition that the granular encapsulating resin composition 30 may contain will be described in detail, and thereafter, an example of a preparation method of the granular encapsulating resin composition 30 will be described.

### [(a) Epoxy Resin]

Examples of the epoxy resin (a) are general monomers, oligomers, and polymers having two or more epoxy groups in one molecule, and the molecular weights and molecular structures thereof are not particularly limited, and examples thereof include bisphenol type epoxy resins such as biphenyl type epoxy resins, bisphenol A-type epoxy resins, bisphenol F-type epoxy resins, and tetramethyl bisphenol F-type epoxy resins, crystalline epoxy resins such as stilbene type epoxy resins and hydroquinone type epoxy resins; novolak type epoxy resins such as cresol novolak-type epoxy resins, phenol novolak type epoxy resins, and naphthol novolak type epoxy resins; phenol aralkyl type epoxy resins such as phenylene skeleton-containing phenol aralkyl type epoxy resins, biphenylene skeleton-containing phenol aralkyl type epoxy resins, phenylene skeleton-containing naphthol aralkyl type epoxy resins, and alkoxy naphthalene skeleton-containing phenol aralkyl epoxy resins; trifunctional epoxy resins such as triphenolmethane type epoxy resins and alkyl-modified triphenolmethane type epoxy resin; modified phenol type epoxy resins such as dicyclopentadiene-modified phenol type epoxy resins and terpene-modified phenol type epoxy resins; heterocyclic ring-containing epoxy resins such as triazine nucleus-containing epoxy resins. These may be used singly or as a combination of two or more types. It is preferable that the equivalent weight of epoxy having a biphenyl skeleton in the molecular structure used be equal to or more than 180.

Although the lower limit value of the blending ratio of the overall epoxy resin is not particularly limited, equal to or more than 2 mass % in the entire resin composition is preferable, equal to or more than 4 mass % is more preferable, and equal to or more than 5 mass % is still more preferable. When the lower limit value of the blending ratio is within the above range, there is little concern of lowering or the like of the fluidity being caused. In addition, although the upper limit value of the blending ratio of the overall epoxy resin is not particularly limited, equal to or less than 25 mass % in the entire resin composition is preferable, equal to or less than 20 mass % is more preferable, and equal to or less than 13 mass % is still more preferable. When the upper limit value of the blending ratio is within the above range, there is little concern of lowering or the like of the soldering resistance being caused. Because consolidation occurs less easily, it is desirable that the blending ratio is adjusted as appropriate according to the type of epoxy resin used.

### [(b) Curing Agent]

The curing agent (b) is not particularly limited as long as it causes curing by reacting with an epoxy resin, and examples thereof include amines such as straight-chain aliphatic diamines having 2 to 20 carbon atoms, such as ethylenediamine, trimethylene diamine, tetramethylene diamine and hexamethylenediamine, meta-phenylenediamine, paraphenylenediamine, paraxylene diamine, 4,4′-diaminodiphenyl methane, 4,4′-diaminodiphenyl propane, 4,4′-diaminodiphenyl ether, 4,4′-diaminodiphenyl sulfone, 4,4′-diamino dicyclohexane, bis(4-aminophenyl)phenyl methane, 1,5-diamino naphthalene, meta-xylene diamine, paraxylene diamine, 1,1-bis(4-aminophenyl)cyclohexane, and dicyandiamide; resol phenol resins such as aniline-modified resol resins, and dimethyl ether resol resins; novolak type phenol resins such as phenol novolak resins, cresol novolak resins, tert-butylphenol novolak resins, and nonylphenol novolak resins; phenol aralkyl resins such as phenylene skeleton-containing phenol aralkyl resins and biphenylene skeleton-containing phenol aralkyl resins; phenol resins having a condensed polycyclic structure such as a naphthalene skeleton and an anthracene skeleton; polyoxyethylene styrenes such as poly-paraoxystyrene; acid anhydrides including alicyclic acid anhydrides such as hexahydrophthalic anhydride (HHPA) and methyltetrahydrophthalic anhydride (MTHPA), aromatic acid anhydrides such as trimellitic anhydride (TMA), anhydrous pyromellitic dianhydride (PMDA), and benzophenonetetracarboxylic dianhydride (BTDA); polymercaptan compounds such as polysulfide, thioester, and thioethers; isocyanate compounds such as isocyanate prepolymers, and blocked isocyanates; and organic acids such as carboxylic acid-containing polyester resins. These may be used singly or as a combination of two or more types. In addition, in terms of moisture resistance, reliability and the like, among these, compounds having at least two phenolic hydroxyl groups in one molecule are preferred as the curing agent used for the semiconductor encapsulating material, and examples thereof include novolak-type phenolic resins such as phenol novolak resins, cresol novolak resins, tert-butylphenol novolak resins, nonylphenol novolak resins, and trisphenolmethane novolak resins; resol-type phenolic resins; polyoxystyrenes such as polyparaoxystyrene; phenylene skeleton-containing phenol aralkyl resins, and biphenylene skeleton-containing phenol aralkyl resins. It is preferable that the equivalent weight of the hydroxyl group having a phenylene and/or biphenyl skeleton in the molecular structure used be equal to or more than 160.

Although the lower limit value of the blending ratio of the overall epoxy resin is not particularly limited, equal to or more than 1.5 mass % in the entire resin composition is preferable, equal to or more than 3 mass % is more preferable, and equal to or more than 5 mass % is still more preferable. When the lower limit value of the blending ratio is within the above range, it is possible to obtain sufficient liquidity. In addition, although the upper limit value of the blending ratio of the overall curing agent is not particularly limited, equal to or less than 20 mass % in the entire resin composition is preferable, equal to or less than 15 mass % is more preferable, and equal to or less than 8 mass % is still more preferable. When the upper limit value of the blending ratio is within the above range, it is possible to obtain satisfactory soldering resistance. Because consolidation occurs less easily, it is desirable that the blending ratio is adjusted as appropriate according to the type of curing agent used.

In a case in which a phenol resin based coupling agent is used as the curing agent, as the compounding ratio of the overall epoxy resin and the overall phenol resin based curing agent, it is preferable that the equivalence ratio (EP)/(OH) of the number of epoxy groups (EP) of the overall epoxy resin and the number of phenolic hydroxyl groups (OH) of the overall phenol resin based curing agent be equal to or more than 0.8 and equal to or less than 1.3. When the equivalence ratio is in this range, it is possible to obtain sufficient curability during molding of the resin composition. When the equivalence ratio is in this range, it is possible to obtain favorable physical characteristics in the resin cured product. Taking a reduction of warpage in an area surface mounted-type semiconductor device into consideration, it is desirable to adjust the equivalence ratio (Ep/Ph) of the number of epoxy groups (Ep) of the overall epoxy resin and the number of phenolic hydroxyl groups (Ph) of the overall curing agent according to the type of curing accelerator used so as to be able to increase the curability of the resin composition, and the glass-transition temperature or the elastic modulus during heating of the resin cured product. In order for the meltability to be increased, it is desirable to appropriately adjust the equivalence ratio according to the type of epoxy resin and phenol resin based curing agent used.

The lower limit value of the blending ratio of the overall epoxy resin and the overall phenol resin based curing agent in the granular encapsulating resin composition is preferably equal to or more than 3.5 mass %, more preferably equal to or more than 7 mass %, and still more preferably equal to or more than 10 mass %. The upper limit value is preferably equal to or less than 45 mass %, more preferably equal to or less than 35 mass %, and still more preferably equal to or less than 21 mass %. By the blending ratio being within this range, it is possible for the reliability of the electronic component, such as soldering resistance, and the moldability such as the fluidity and the filling ability to be favorable, and possible for consolidation to occur less easily.

### [(c) Inorganic Filler]

The inorganic filler (c) is not particularly limited if the consolidation properties are good when the granular encapsulating resin composition 30 is used, and examples thereof include silicas such as fused crushed silica, fused spherical silica, crystalline silica, and secondary flocculated silica; alumina, silicon nitride, aluminum nitride, boron nitride, titanium oxide, silicon carbide, aluminum hydroxide, magnesium hydroxide, titanium white, talc, clay, mica, and glass fibers. Among these, silica is particularly preferable, and fused spherical silica is still more preferable. The particle shape is preferably infinitely spherical, and it is possible to increase the filler content by mixing particles of different sizes. In order to improve the meltability of the resin composition, it is preferable that fused spherical silica be used.

The inorganic filler (c) may be one type or a blend of two or more types of fillers, and the overall specific surface area (SSA) thereof is preferably equal to or less than 5 m²/g and the lower limit is preferably equal to or more than 0.1 m²/g, and more preferably equal to or more than 2 m²/g. The average particle diameter (D₅₀) of the overall inorganic filler (c) is preferably equal to or more than 1 μm and equal to or less than 30 μm, more preferably equal to or more than 2 μm and equal to or less than 20 μm, and still more preferably equal to or more than 5 μm and equal to or less than 20 μm.

It is possible to use two or more types of inorganic fillers with different specific surface areas (SSA) and/or average particle diameters (D₅₀) as the inorganic filler.

An example of an inorganic filler with a relatively large average particle diameter (D₅₀) is spherical silica for which the average particle diameter (D₅₀) is preferably equal to or more than 5 μm and equal to or less than 35 μm, and more preferably equal to or more than 10 μm and equal to or less than 30 μm. The content rate of such an inorganic filler with a relatively large average particle diameter (D₅₀) is preferably equal to or more than 10 mass %, more preferably equal to or more than 20 mass %, and still more preferably equal to or more than 60 mass % with respect to the overall inorganic filler (c).

A preferred example of an inorganic filler with a relatively large average particle diameter (D₅₀) includes (c1) fused spherical silica with an average particle diameter (D₅₀) of equal to or more than 5 μm and equal to or less than 35 μm, and having a particle size distribution that satisfies any of (i) to (v) below.

(i) includes 1 to 4.5 mass % of particles with a particle size of equal to or less than 1 μm, with the overall fused spherical silica (c1) as a standard,

(ii) includes equal to or more than 7 mass % and equal to or less than 11 mass % of particles with a particle size of equal to or less than 2 μm,

(iii) includes equal to or more than 13 mass % and equal to or less than 17 mass % of particles with a particle size of equal to or less than 3 μm,

(iv) includes equal to or more than 2 mass % and equal to or less than 7 mass % of particles with a particle size exceeding 48 μm, and

(v) includes equal to or more than 33 mass % and equal to or less than 40 mass % of particles with a particle size exceeding 24 μm.

The content rate of such a fused spherical silica (c1) is preferably equal to or more than 10 mass % in the inorganic filler (c), more preferably equal to or more than 20 mass %, and still more preferably equal to or more than 60 mass %. By doing so, it is possible to further improve the meltability.

An example of an inorganic filler with a relatively large average particle diameter (D₅₀) is spherical silica for which the specific surface area is preferably equal to or more than 0.1 m²/g and equal to or less than 5.0 m²/g, and more preferably equal to or more than 1.5 m²/g and equal to or less than 5.0 m²/g. The content rate of such a spherical silica is preferably equal to or more than 10 mass %, more preferably equal to or more than 20 mass %, and still more preferably equal to or more than 60 mass % with respect to inorganic filler (c).

An example of an inorganic filler with a relatively small average particle diameter (D₅₀) is spherical silica for which the average particle diameter (D₅₀) is preferably equal to or more than 0.1 μm and less than 5 μm. The content rate of such an inorganic filler with a relatively small average particle diameter (D₅₀) is preferably equal to or less than 60 mass %, more preferably equal to or less than 45 mass %, and still more preferably equal to or less than 30 mass % with respect to the overall inorganic filler.

A preferred example of an inorganic filler with a relatively small average particle diameter (D₅₀) is fused spherical silica (c2) with an average particle diameter (D₅₀) of equal to or more than 0.1 μm and less than 5 μm, more preferred examples include fused spherical silica (c3) with an average particle diameter (D₅₀) of equal to or more than 0.1 μm and equal to or less than 1 μm, and fused spherical silica (c4) with an average particle diameter (D₅₀) of equal to or more than 1 μm and less than 5 μm used singly or in combination.

An example of an inorganic filler with a relatively large average particle diameter (D₅₀) is spherical silica for which the specific surface area is preferably equal to or more than 3.0 m²/g and equal to or less than 10.0 m²/g, and more preferably equal to or more than 3.5 m²/g and equal to or less than 8 m²/g. The content rate of such a spherical silica is preferably equal to or less than 80 mass %, more preferably equal to or less than 50 mass %, and still more preferably equal to or less than 20 mass % with respect to the overall inorganic filler (c).

As a more preferable aspect of a case in which inorganic fillers (c) have different specific surface areas (SSA) and/or average particle diameter (D₅₀), it is preferable that equal to or more than 70 mass % and equal to or less than 94 mass % of fused spherical silica (c1) be included, and equal to or more than 6 mass % and equal to or less than 30 mass % of (c2) fused spherical silica be included in the inorganic filler (c). A more preferable aspect may include equal to or more than 70 mass % and equal to or less than 94 mass % of fused spherical silica (c1) in the inorganic filler (c), and may include equal to or more than 1 mass % and equal to or less than 29 mass % of fused spherical silica (c3) with an average particle diameter (D₅₀) of equal to or more than 0.1 μm and equal to or less than 1 μm and equal to or more than 1 mass % and equal to or less than 29 mass % of fused spherical silica (c4) with an average particle diameter (D₅₀) of equal to or more than 1 μm and equal to or less than 5 μm, and the total amount of (c3) and (c4) is equal to or more than 6 mass % and equal to or less than 30 mass %. By doing so, a much improved meltability is preferably realized.

In the embodiment, the specific surface area (SSA) of the inorganic filler is obtained by measuring with a commercially available specific surface meter (for example, MACSORB HM MODEL-1201 manufactured by Mountech, Co., Ltd.). The average particle diameter (D₅₀) and the particle size of the inorganic filler are obtained by measuring with a commercially available laser particle size analyzer (for example, a SALD-7000 manufactured by Shimadzu Corporation).

As the lower limit value of the content ratio of the inorganic filler (c), equal to or more than 60 mass % is preferable with the overall encapsulating resin composition 30 of the embodiment as a standard, and equal to or more than 75 mass % is more preferable. When the lower limit value of the content ratio is within the above range, it is possible to obtain satisfactory solder crack resistance without increasing the amount of moisture absorbed or lowering the strength as physical properties of the cured product of the resin composition, and consolidation occurs less easily. As the upper limit value of the content ratio of the inorganic filler, equal to or less than 95 mass % of the entire resin composition is preferable, equal to or less than 92 mass % is more preferable, and equal to or less than 90 mass % is particularly preferable. When the upper limit value of the content ratio of the inorganic filler is within the above range, it is possible to obtain favorable moldability without impeding the fluidity. In a range in which favorable soldering resistance is obtained, it is preferable that the content of the inorganic filler be set low.

### [(d) Curing Accelerator]

It is possible to use a curing accelerator (d) generally used in encapsulating materials as long as the curing reaction between the epoxy group and the phenolic hydroxyl group is promoted. Specific examples include phosphorus atom-containing compounds such as organic phosphines, tetra-substituted phosphonium compounds, phosphobetaine compounds, adducts of a phosphine compound and a quinone compound, and adducts of a phosphonium compound and a silane compound; and nitrogen atom-containing compounds represented by 1,8-diazabicyclo(5,4,0) undecene-7, amidine-based compounds such as imidazole, amidinium salts that are tertiary amines such as benzyl dimethyl amine or a quaternary onium salt of the compound, and ammonium salts. Among these, phosphorous atom-containing compounds are preferable from the viewpoint of curability, and from the viewpoint of balance of the fluidity and the curability, a curing accelerator having latency, such as tetra-substituted phosphonium compounds, phosphobetaine compounds, adducts of phosphine compounds and quinone compounds, and adducts of phosphonium compounds and silane compounds are preferable. Taking fluidity into consideration, tetra-substituted phosphonium compounds are particularly preferable, phosphobetaine compounds and adducts of phosphine compounds and quinone compounds are particularly preferable from the viewpoint of soldering resistance, and adducts of phosphonium compounds and silane compounds are particularly preferable when taking latent curability into consideration. In addition, from the viewpoint of continuous moldability, tetra-substituted phosphonium compounds are preferable. When cost terms are considered, organic phosphine and nitrogen atom-containing compounds are also suitably used.

Examples of the organic phosphine able to be used in the granular encapsulating resin composition 30 according to the present embodiment include primary phosphines such as ethylphosphine, and phenylphosphine; secondary phosphines, such as dimethylphosphine, and diphenylphosphine; and tertiary phosphines such as trimethylphosphine, triethylphosphine, tributylphosphine, and triphenylphosphine.

Examples of the tetra-substituted phosphonium compound able to be used in the epoxy resin composition according to the embodiment include the compounds represented by, for example, general formula (1) below.

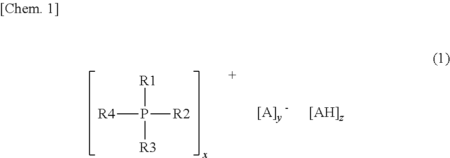

In general formula (1), P represents a phosphorus atom, R1, R2, R3, and R4 each independently represent an aromatic group or an alkyl group, A represents an anion of an aromatic organic acid having at least one functional group selected from a hydroxyl group, a carboxyl group, and a thiol group in the aromatic ring, AH represents an aromatic organic acid having at least one functional group selected from a hydroxyl group, a carboxyl group, and a thiol group in the aromatic ring, x and y represent a number from 1 to 3, z represents a number from 0 to 3 and x=y.

Although the compound represented by general formula (1) is obtained, for example, as below, there is no limitation thereto. First, a tetra-substituted phosphonium halide, an aromatic organic acid, and a base are uniformly mixed in an organic solvent, and an aromatic organic acid anion is generated in the solution system. Next, water is added, and a compound represented by general formula (1) is able to be precipitated. In the compound represented by general formula (1), from the viewpoint of superiority in the balance between yield and curing acceleration effect during synthesis, R1, R2, R3, and R4 are preferably a phenyl group bonded to a phosphorus atom, AH is preferably a compound having a hydroxyl group in the aromatic ring, that is, a phenol compound, and A is preferably an anion of the phenol compound. The phenol compound includes the concept of a monocyclic phenol, cresol, catechol, resorcin or condensed polycyclic naphthol, dihydroxynaphthalin, bisphenol A, bisphenol F, bisphenol S, biphenol, phenylphenol, and phenol novolak including a plurality of aromatic rings (polycyclic), and among these, phenol compounds having 2 hydroxyl groups are preferably used.

Examples of the phosphobetaine compound able to be used in the epoxy resin composition according to the embodiment include the compounds represented by, for example, general formula (2) below.

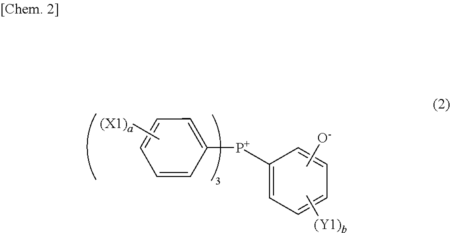

In general formula (2), X1 represents an alkyl group with 1 to 3 carbon atoms, Y1 represents a hydroxyl group, a is an integer of 0 to 5, and b is an integer of 0 to 4.

The compound represented by general formula (2) is obtained, for example, as below. The compound is obtained through a process of a tri-aromatic substituted phosphine that is a tertiary phosphine and a diazonium salt being brought into contact, and a tri-aromatic substituted phosphine and a diazonium group having diazonium salt being substituted. However, there is no particular limitation thereto.

Examples of the adducts of a phosphine compound and a quinone compound able to be used in the epoxy resin composition according to the embodiment include, for example, compounds represented by the general formula (3) below.

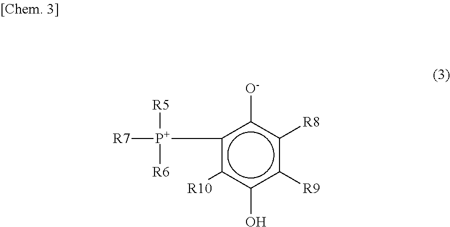

In general formula (3), P represents a phosphorus atom, R5, R6, and R7 each independently represent an alkyl group with 1 to 12 carbon atoms or an aryl group with 6 to 12 carbon atoms, R8, R9, and R10 each independently represent a hydrogen atom or a hydrocarbon group with 1 to 12 carbon atoms, and R8 and R9 form a ring by bonding with each other.

As the phosphine compound used in the adduct of a phosphine compound and a quinone compound, for example, compounds such as triphenylphosphine, tris(alkylphenyl)phosphine, tris(alkoxyphenyl)phosphine, trinaphtylphosphine, and tris(benzyl)phosphine having a non-substituted aromatic ring or a substituted aromatic ring having a substituent such as an alkyl group and an alkoxy group are preferable, and examples of the substituent include those having 1 to 6 carbon atoms, such as an alkyl group and an alkoxy group. From the viewpoint of ease of procurement, triphenylphosphine is preferable.

Examples of the quinone compound used in the adduct of a phosphine compound and a quinone compound include o-benzoquinone, p-benzoquinone, and anthraquinones, and among these, p-benzoquinone is preferable in terms of storage stability.

The preparation method of the adduct of a phosphine compound and a quinone compound is able to obtain the adduct through the organic tertiary phosphine and the benzoquinone being brought into contact with a solvent able to dissolve both, and being mixed. As the solvent, ketones such as acetone or methyl ethyl ketone with low solubility to the adduct may be used. However, there is no particular limitation thereto.

In the compound represented by the general formula (3), a compound in which R5, R6 and R7 that bond with the phosphorus atom are phenyl groups, and R8, R9 and R10 are hydrogen atoms, that is, a compound to which 1,4-benzoquinone and triphenylphosphine are added is preferable in terms of lowering the elastic modulus of the cured epoxy resin composition during heating.

Examples of the adducts of a phosphonium compound and a silane compound able to be used in the epoxy resin composition according to the embodiment include, for example, compounds represented by the general formula (4) below.

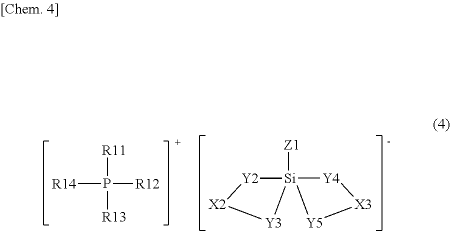

In general formula (4), P represents a phosphorus atom, and Si represents a silicon atom. R11, R12, R13, and R14 each independently represent an organic group having an aromatic ring or a heterocycle, or an aliphatic group, and X2 represents an organic group bonded to groups Y2 and Y3. X3 is an organic group that bonds with groups Y4 and Y5. Y2 and Y3 represent a proton donating group from which a proton is released, and form a chelate structure by the groups Y2 and Y3 in the same molecule bonding with a silicon atom. Y4 and Y5 represent a proton donating group from which a proton is released, and form a chelate structure by the groups Y4 and Y5 in the same molecule bonding with a silicon atom. X2 and X3 may be the same as or different to one another, and Y2, Y3, Y4, and Y5 may be the same as or different to one another. Z1 is an organic group having an aromatic ring or a heterocycle, or an aliphatic group.

In general formula (4), for example, examples of R11, R12, R13, and R14 include a phenyl group, a methylphenyl group, a methoxyphenyl group, a hydroxyphenyl group, a naphthyl group, a hydroxynaphthyl group, a benzyl group, a methyl group, an ethyl group, an n-butyl group, an n-octyl group, and a cyclohexyl group, and among these, an aromatic group having a substituent such as a phenyl group, a methylphenyl group, a methoxyphenyl group, a hydroxyphenyl group, and a hydroxynaphthyl group, or an unsubstituted aromatic group are preferable.

In general formula (4), X2 is an organic group bonded to Y2 and Y3. Similarly, X3 is an organic group that bonds with groups Y4 and Y5. Y2 and Y3 represent a proton donating group from which a proton is released, and form a chelate structure by the groups Y2 and Y3 in the same molecule bonding with a silicon atom. Similarly, Y4 and Y5 represent a proton donating group from which a proton is released, and form a chelate structure by the groups Y4 and Y5 in the same molecule bonding with a silicon atom. Groups X2 and X3 may be the same as or different to one another, and groups Y2, Y3, Y4, and Y5 may be the same as or different to one another. Such groups represented by —Y2-X2-Y3- and —Y4-X3-Y5- in general formula (4) are proton donors constituted by groups emitting two protons, and as the proton donors, an organic acid having at least two carboxyl groups or hydroxyl groups in the molecule is preferable, an aromatic compound having at least two carboxyl groups or hydroxyl groups on the carbon constituting the aromatic ring is more preferable, and an aromatic compound having at least two hydroxyl groups on adjacent carbons constituting the aromatic ring is still more preferable. For example, examples include catechol, pyrogallol, 1,2-dihydroxynaphthalene, 2,3-dihydroxynaphthalene, 2,2′-biphenol, 1,1′-bi-2-naphthol, salicylic acid, 1-hydroxy-2-naphthoic acid, 3-hydroxy-2naphthoic acid, chloranilic acid, tannic acid, 2-hydroxybenzyl alcohol, 1,2-cyclohexane diol, 1,2-propanediol, and glycerin. Among these, from the viewpoint of a balance of easy of procurement of the raw materials and the curing acceleration effect, catechol, 1,2-dihydroxynaphthalene, and 2,3-dihydroxynaphthalene are more preferable.

Z1 in general formula (4) represents an organic group having an aromatic ring or a heterocycle, or an aliphatic group, and specific examples include an aliphatic hydrocarbon group such as a methyl group, an ethyl group, a propyl group, a butyl group, a hexyl group and an octyl group; an aromatic hydrocarbon group such as a phenyl group, a benzyl group, a naphthyl group and a biphenyl group; and a reactive substituent such as a glycidyloxypropyl group, mercaptopropyl group, an amino propyl group and a vinyl group; however, among these a methyl group, an ethyl group, a phenyl group, a naphthyl group, and a biphenyl group are more preferable in terms of thermal stability.

As the preparation method of the adduct of a phosphonium compound and a silane compound, methanol is introduced to a flask, a proton donor, such as a silane compound such as phenyltrimethoxysilane, or 2,3-dihydroxynaphthalene was added and melted, and next, sodium methoxide-methanol solution is added dropwise to the solution under stirring at room temperature. A solution in which a tetra-substituted phosphonium halide such as a tetraphenylphosphonium bromide prepared in advance is melted in methanol is added dropwise to the solution under stirring at room temperature, and crystals were precipitated. The precipitated crystals were filtered, washed and vacuum dried, thus obtaining the adduct of a phosphonium compound and a silane compound. However, there is no particular limitation thereto.

The lower limit value of the blending ratio of the overall curing accelerator is preferably equal to or more than 0.1 mass % in the entire resin composition. When the lower limit value of the blending ratio of the overall curing accelerator is within the above range, it is possible to obtain sufficient curability. The upper limit value of the blending ratio of the overall curing accelerator is preferably 1 mass % or less in the entire resin composition. When the upper limit value of the blending ratio of the overall curing accelerator is within the above range, it is possible to obtain sufficient fluidity. It is desirable that the blending ratio be appropriately adjusted according to the type of curing accelerator used in order for the meltability to be improved.

### [(e) Coupling Agent]

It is possible to use known coupling agents such as various silane-based compounds such as epoxy silane, mercapto silane, aminosilane, alkyl silane, ureidosilane, and vinyl silane; titanium-based compounds; aluminum chelates; and aluminum or zirconium-based compounds as the coupling agent (e). Examples thereof include silane coupling agents such as hydrolysis products of vinyl trichlorosilane, vinyl trimethoxysilane, vinyl triethoxysilane, vinyl tris(β-methoxyethoxy)silane, γ-methacryloxypropyl trimethoxysilane, β-(3,4-epoxy cyclohexyl)ethyl trimethoxysilane, γ-glycidoxypropyltrimethoxysilane, γ-glycidoxypropyltriethoxysilane, γ-glycidoxypropyl methyl dimethoxy silane, γ-methacryloxypropyl methyldiethoxysilane, γ-methacryloxypropyltriethoxysilane vinyltriacetoxysilane, γ-mercaptopropyl trimethoxysilane, γ-aminopropyltriethoxysilane, γ-anilino propyltrimethoxysilane, γ-anilino propylmethyldimethoxysilane, γ-[bis(β-hydroxyethyl)]aminopropyltriethoxysilane, N-β-(aminoethyl)-γ-aminopropyltrimethoxysilane, N-β-(aminoethyl)-γ-aminopropyltriethoxysilane, N-β-(aminoethyl)-γ-aminopropyl methyl dimethoxy silane, N-phenyl-γ-aminopropyltrimethoxysilane, γ-(β-aminoethyl)aminopropyl dimethoxymethylsilane, N-(trimethoxysilylpropyl)ethylenediamine, N-(dimethoxymethylsilyl isopropyl)ethylene diamine, methyl trimethoxysilane, dimethyl dimethoxy silane, methyl triethoxysilane, N-β-(N-vinyl benzyl aminoethyl)-γ-aminopropyltrimethoxysilane, γ-chloropropyl trimethoxysilane, hexamethyldisilane, vinyl trimethoxysilane, γ-mercaptopropylmethyldimethoxysilane, 3-isocyanatopropyltriethoxysilane, 3-acryloxypropyltrimethoxysilane, 3-triethoxyl-N-(1,3-dimethylbutylidene)propylamine, and titanate coupling agents such as isopropyltriisostearoyl titanate, isopropyl tris(dioctyl pyrophosphate) titanate, isopropyl tri(N-amino ethyl-aminoethyl)titanate, tetraoctyl bis(ditridecylphosphite) titanate, tetra(2,2-diallyloxymethyl-1-butyl)bis(ditridecyl)phosphite titanate, bis(dioctyl pyrophosphate)oxyacetate titanate, bis(dioctyl pyrophosphate) ethylene titanate, isopropyltrioctanoyl titanate, isopropyl dimethacryl isostearoyl titanate, isopropyl tridodecylbenzenesulfonyl titanate, isopropyl isostearoyl diacryl titanate, isopropyl tri(dioctyl phosphate) titanate, isopropyltricumylphenyl titanate, and tetraisopropyl bis(dioctyl phosphite) titanate. These may be used singly or in a combination of two or more.

The blending amounts of the coupling agent (e) is preferably equal to or more than 0.05 mass % and equal to or less than 3 mass %, and more preferably equal to or more than 0.1 mass % and equal to or less than 2.5 mass % with respect to the inorganic filler (c). It is possible to favorably adhere the frame by setting to equal to or more than 0.05 mass %, and it is possible for the moldability to be improved by setting to equal to or less than 3 mass %.

### [Others]

In addition to the above components it is possible to blend as necessary coloring agents such as carbon black; mold releasing agents such as natural wax, synthetic wax, higher fatty acids or metallic salts thereof, paraffin, and polyethylene oxide; low stress agents such as silicone oil and silicone rubber; ion scavengers such as hydrotalcite; flame retardants such as aluminum hydroxide; and various additives such as antioxidants in the granular encapsulating resin composition 30 of the embodiment.

### [Glass-Transition Temperature of Encapsulating Resin Composition]

The glass-transition temperature (that is, the glass-transition temperature of the composition before being cured) of the granular encapsulating resin composition of the embodiment obtained by the above-described preparation method using, as appropriate, the preferred components and the like described below is preferably equal to or more than 15° C. and equal to or less than 30° C. By setting in the above range, consolidation becomes difficult, and it is possible to have a preferred form in which the resin composition melts immediately on the die.

The glass-transition temperature of the granular encapsulating resin composition is measured at 5° C./min at atmospheric pressure using modulated differential scanning calorimetry (below, denoted as a modulated DSC or MDSC) and a value is obtained according to JISK 7121.

### [Preparation Method]

Next, an example of the preparation method of the granular encapsulating resin composition 30 will be described.

The granular encapsulating resin composition 30 of the embodiment is made granular through one or a combination of various methods, such as crushing, granulation, extrusion cutting and sieving, after mixing and kneading. For example, examples include a method of premixing each raw material component in a mixer, heating and kneading the raw material components by a kneading machine such as a roller, a kneader or an extruder, supplying the molten kneaded resin composition to the inside of a rotor configured from a cylindrical outer peripheral portion having a plurality of pores, and a disk-like bottom surface, and passing the resin composition through the pores by centrifugal force obtained by rotating the rotor (centrifugal milling method); a method of obtaining a crushed product through cooling and crushing processes and removing a coarse powder and a fine power using a sieve, after kneading similarly to above (crushing and sieving method); and a method of, after preparatory mixing of each raw material component in a mixer, performing heating and kneading using an extruder in which a die is provided on which a plurality of paths are arranged on the tip portion of a screw, and cutting a molten resin extruded strand-like from small holes arranged in the die with a cutter that slides and rotates substantially parallel to the die surface (below, referred to as a “hot cutting method”). It is possible to obtain a desired particle size distribution and bulk density in any of the methods by selecting the kneading conditions, centrifuging conditions, the sieving conditions, the cutting conditions and the like. The centrifugal milling method, for example, is disclosed in Japanese Unexamined Patent Publication No. 2010-159400.

### <Inner Packaging Material 20>

The granular encapsulating resin composition 30 is directly accommodated in the inner packaging material 20. The inner packaging material 20, for example, may be a bag such as a plastic bag (for example, a polyethylene bag), and a paper bag, or may be a plastic vessel, a metal vessel or the like, having a predetermined strength. After the granular encapsulating resin composition 30 is accommodated, the inner packaging material 20 is sealed. The sealing unit is not particularly limited, and it is possible to use any means in the related art.

### <Outer Packaging Material 10>

The inner packaging material 20 in which the granular encapsulating resin composition 30 is accommodated and sealed is accommodated in the outer packaging material 10. The granular encapsulating resin composition 30 may be directly accommodated in the outer packaging material 10. The outer packaging material 10, for example, may be a container having a predetermined strength such as a metal can and a cardboard box. As the usage form of the outer packaging material 10, a case in which a plurality of outer packaging materials 10 are stacked in multiple stages, and other articles and the like are stacked on the outer packaging material 10 is considered. Assuming such as usage form, the outer packaging material 10 preferably has strength to the extent that the outer packaging material 10 does not greatly deform even if a predetermined weight (design matter) of articles are stacked, and the weight of the articles is not applied to the granular encapsulating resin composition 30 accommodated in the inner portion of the outer packaging material 10.

### <Packaging Method>

As shown in FIG. 1, in the embodiment, the granular encapsulating resin composition 30 is accommodated in the inner packaging material 20, and the inner packaging material 20 after being sealed is accommodated in the outer packaging material 10. The relationship M×L≦19 is satisfied when the bulk density of the granular encapsulating resin composition 30 is M (g/cc), and the height of the deposited material due to the granular encapsulating resin composition 30 is L (cm) in a state of being accommodated in the packaging material. Since the bulk density M of the granular encapsulating resin composition 30 is a value determined by the performance requirements or the like of the granular encapsulating resin composition 30, there are numerous cases in which adjusting (changing) the value in order to realize the effect of the embodiment is difficult. Here, in the embodiment, the height L (cm) of the deposited material is controlled based on the bulk density M of the granular encapsulating resin composition 30 determined by the performance requirements or the like. More specifically, the upper limit of the height L (cm) of the deposited material is controlled to satisfy the relationship M×L≦19. For example, in a case in which the bulk density M of the granular encapsulating resin composition 30 is equal to or more than 0.70 g/cc and equal to or less than 0.95 g/cc, the height L is equal to or less than 25 cm, preferably equal to or less than 23 cm, more preferably equal to or less than 20 cm and still more preferably equal to or less than 15 cm. In a case in which the bulk density M of the granular encapsulating resin composition 30 is equal to or more than 1.0 g/cc and equal to or less than 1.3 g/cc, the height L is equal to or less than 14.6 cm, and preferably equal to or less than 13 cm.

Control of the upper limit of the height L (cm) of the granular encapsulating resin composition 30 is realized by adjusting the shape and the size of the space, and the amount accommodated and the like of the space that accommodates the granular encapsulating resin composition 30. In addition, for example, this may be realized by controlling the upper limit of the height H (cm) of the inner packaging material 20 (L≦H). In a case in which the bulk density M of the granular encapsulating resin composition 30 is equal to or more than 0.70 g/cc and equal to or less than 0.95 g/cc, the height H is adjusted to be equal to or less than 25 cm, preferably equal to or less than 23 cm, more preferably equal to or less than 20 cm, and still more preferably equal to or less than 15 cm. Similarly, in a case in which the bulk density M of the granular encapsulating resin composition 30 is equal to or more than 1.0 g/cc and equal to or less than 1.3 g/cc, the height H is adjusted to be equal to or less than 14.6 cm, and preferably equal to or less than 13 cm. Alternatively, this may be realized by controlling the upper limit of the height (cm) of the space that accommodates the inner packaging material 20 formed by the outer packaging material 10 (L≦H≦N).

The inventor discovered that, in a case in which the granular encapsulating resin composition 30 is packaged, and the force of its own weight is controlled (upper limit is controlled) to satisfy M×L≦19, defects where a portion of the granular encapsulating resin composition 30 consolidates during storage are suppressed.

Here, the heights H and N indicate the height in a state of a predetermined surface of the inner packaging material 20 and/or the outer packaging material 10 being placed on the ground surface as the bottom surface according to ordinary convention (the same applies below). For example, in a case in which information (text, symbols, or the like) that specifies the top and bottom of the packaging material is applied, the height indicates the height in a state in which the packaging material is placed on the ground surface according to the information. In a case in which a pattern composed of text, images or the like is attached to the side surface of the packaging material, the height indicates the height in a state in which the packaging material is placed on the ground surface so that the vertical of the pattern is correct. However, in the embodiment, no matter the orientation the outer packaging material is printed in, taking the actions and effects of the embodiment in to consideration in the course of distribution and storage, in a case in which the height from the lower end of the packaging material upwards is measured in a case in which the direction of gravity is the downward direction and the opposite direction is the upward direction, the height is in the range of the embodiment in a case in which the relationship M×H≦19 is satisfied.

It is possible to include a container having a chemical agent with a drying or oxygen absorbing effect in the inner packaging material of the packaging method of the embodiment such as the above packaging method or in the space between the outer packaging material and the inner packaging material in a method not interfering with the effect of the embodiment.

### Modification Example 1

In the embodiment shown in FIG. 1, one inner packaging material 20 is accommodated in one outer packaging material 10. However, a plurality of inner packaging materials 20 are able to be accommodated in one outer packaging material 10.

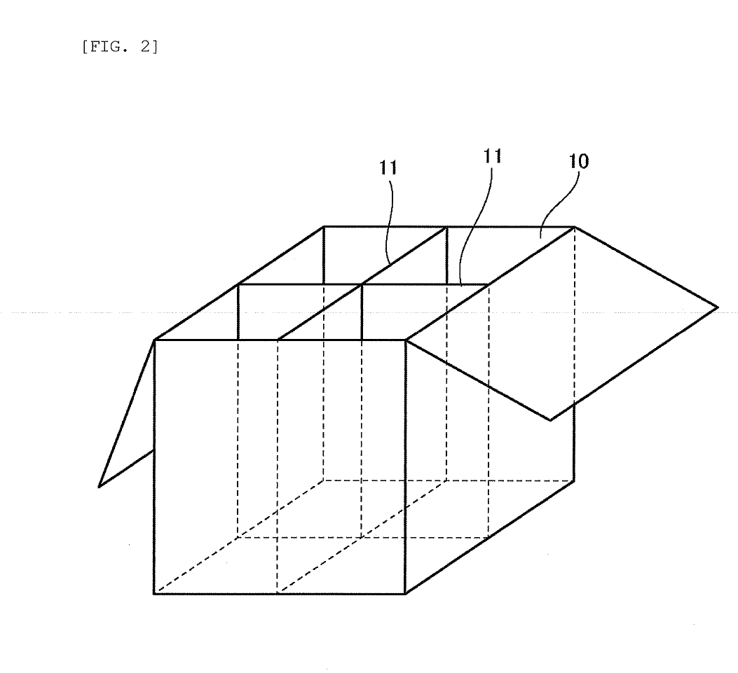

For example, as shown in FIG. 2, the inner portion of the outer packaging material 10 may be divided into a plurality of chambers with partitions 11 extending in the height direction of the outer packaging material 10. A plurality of inner packaging materials 20 (not shown) may be separately accommodated in each of the plurality of chambers. In FIG. 2, although the inner portion of the outer packaging material 10 is divided into 4 chambers, there is no particular limitation to this number. In FIG. 2, although the shape of each chamber is that of a square prism, there is no limitation thereto, and other shapes such as a triangular prism may be used.

Also in the modification example, the granular encapsulating resin composition 30 is packaged to satisfy the relationship M×L≦19. The granular encapsulating resin composition 30 may be packaged to satisfy the relationship M×H≦19. The granular encapsulating resin composition 30 may be packaged to satisfy the relationship M×N≦19.

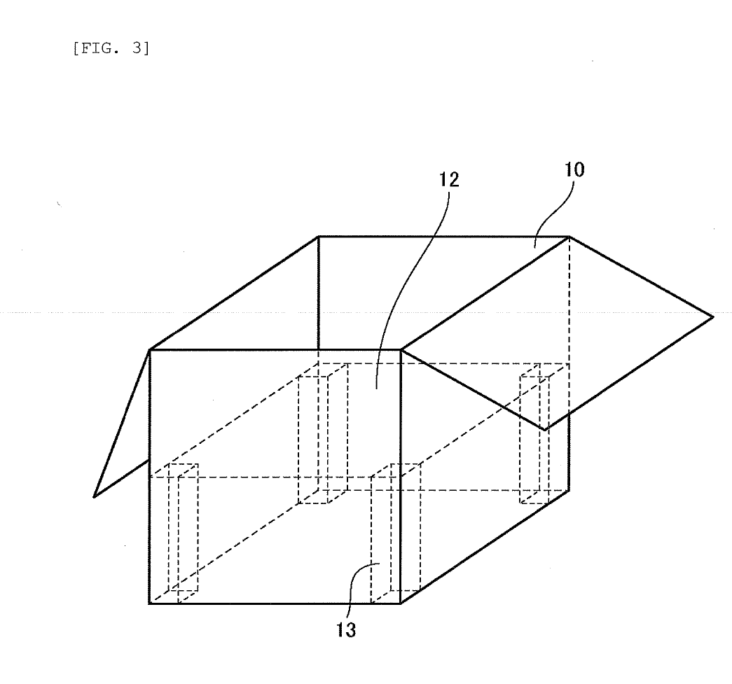

As another modification example, for example, as shown in FIG. 3, the inner portion of the outer packaging material 10 may be divided (divided into upper and lower portions) into a plurality of chambers with partitions 12 extending in a direction substantially perpendicular to the height direction of the outer packaging material 10. A plurality of inner packaging materials 20 (not shown) may be separately accommodated in each of the plurality of chambers. In FIG. 3, although the inner portion of the outer packaging material 10 is divided into 2 chambers, there is no particular limitation to this number.

In a case of a multi-stage configuration in which a plurality of chambers as shown in FIG. 3 are stacked in the height direction of the outer packaging material 10, it is preferable to include an upper stage support unit such that the weight of the inner packaging material 20 accommodated in the chamber of the upper stage side does not affect the granular encapsulating resin composition 30 of the inner packaging material 20 accommodated in the lower stage side chamber. Although the configuration of the upper stage support unit is not particularly limited, for example, as shown in FIG. 3, the upper stage support structure may be realized by bases 13 with a predetermined height provided at the four corners of the outer packaging material 10. The partitions 12 are supported by being placed on the bases 13. The partitions 12 and the bases 13 are strongly configured to resist the weight of the inner packaging material 20 accommodated in the upper stage and in which the granular encapsulating resin composition 30 is accommodated. The bases 13 may be provided at positions other than the four corners of the outer packaging material 10.

In the modification example, in a case in which the weight of the inner packaging material 20 accommodated in the upper stage chamber does not affect the granular encapsulating resin composition 30 of the inner packaging material 20 accommodated in the lower stage chamber, the height L (cm) of the deposited material due to the granular encapsulating resin composition 30 is the height of each deposited material of the granular encapsulating resin composition 30 of the inner packaging material 20 accommodated in each chamber.

Also in the modification example, the granular encapsulating resin composition 30 is packaged to satisfy the relationship M×L≦19. The granular encapsulating resin composition 30 may be packaged to satisfy the relationship M×H≦19. The granular encapsulating resin composition 30 may be packaged to satisfy the relationship M×N≦19. In the case of the modification example, the height N of the space that accommodates the inner packaging material 20 formed by the outer packaging material 10 indicates the height of each chamber that accommodates the inner packaging material 20.

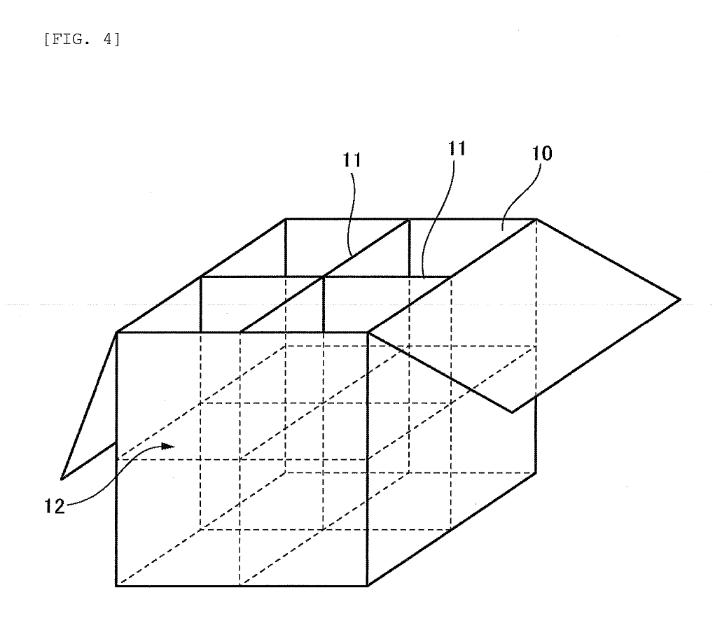

As another modification example, for example, as shown in FIG. 4, the inner portion of the outer packaging material 10 may be divided into a plurality of chambers with partitions 11 extending in the height direction of the outer packaging material 10 and partitions 12 extending in a direction perpendicular to the height direction. An inner packaging material 20 (not shown) may be accommodated in each of the plurality of chambers. In FIG. 4, although the inner portion of the outer packaging material 10 is divided into 8 chambers, there is no particular limitation to this number. Also in the modification example, it is preferable that an upper stage support unit be included; however, this is not shown in FIG. 4.

Also in the modification example, the granular encapsulating resin composition 30 is packaged to satisfy the relationship M×L≦19. The granular encapsulating resin composition 30 may be packaged to satisfy the relationship M×H≦19. The granular encapsulating resin composition 30 may be packaged to satisfy the relationship M×N≦19. In the case of the modification example, the height N of the space that accommodates the inner packaging material 20 formed by the outer packaging material 10 indicates the height of each chamber that accommodates the inner packaging material 20.

In the modification example, it is possible to realize the same actions and effects as the embodiment described using FIG. 1.

### Modification Example 2

In Modification Example 1 shown in FIG. 1, a configuration that limits the maximum value of the force of its own weight to a desired range by adjusting (changing) the height (L, H or N) in a state in which a predetermined surface of the outer packaging material 10 is placed on the ground surface as a bottom surface according to ordinary convention is described. However, by limitation of the storage space or the like, a usage mode that places another surface of the outer packaging material 10 on the ground surface as the bottom surface, without following ordinary convention, is considered.

In the modification example, even if any of a plurality of surfaces that the outer packaging material 10 has is placed on the ground surface as a bottom surface, the configuration is able to limit the maximum value of the force of its own weight to within a desired range.

For example, when the height of the inner packaging material 20 in a state in which surfaces different to the bottom surface of the outer packaging material 10 according to ordinary convention are each placed on the ground surface as the bottom surface is H′, the height is designed to satisfy the relationship M×H′≦19. Alternatively, when the height of the space that accommodates the inner packaging material 20 formed by the outer packaging material 10 in a state in which surfaces different to the bottom surface of the outer packaging material 10 according to ordinary convention are each placed on the ground surface as the bottom surface is N′, the height is designed to satisfy the relationship M×N′≦19. These are able to be realized by adjusting the shape of the inner packaging material 20, or the shape of the outer packaging material 10 and the way of partitioning the inner portion space, or the like.

Other configurations are the same the embodiment shown in FIG. 1 and Modification Example 1. Even in the modification example, it is possible to realize the same actions and effects as the embodiment described using FIG. 1.

### Modification Example 3

In the example shown in FIG. 1, and Modification Examples 1 and 2, the granular encapsulating resin composition 30 is accommodated in the inner packaging material 20, and the inner packaging material 20 is accommodated in the outer packaging material 10. In the modification example, the granular encapsulating resin composition 30 is directly packaged in the outer packaging material 10. Other configurations are the same the example shown in FIG. 1 and Modification Examples 1 and 2.

For example, the granular encapsulating resin composition 30 is directly accommodated in each chamber of the outer packaging material 10 having one or a plurality of chambers with good sealability in the inner portion thereof. Also in the modification example, the granular encapsulating resin composition 30 is packaged to satisfy the relationship M×L≦19. The granular encapsulating resin composition 30 may be packaged to satisfy the relationship M×N≦19. The height N (cm) of each chamber is adjusted to satisfy the relationship M×N≦19. Even in a case in which any of the plurality of outside surfaces that the outer packaging material 10 has is placed on the ground surface as the bottom surface, the height N (cm) of each chamber may be adjusted to satisfy the relationship M×N≦19. The inner portion of the outer packaging material 10 may be divided into a plurality of chambers to have multiple stages. In this case, it is preferable that the outer packaging material 10 be configured so that the weight of the granular encapsulating resin composition 30 accommodated in a given chamber does not affect the granular encapsulating resin composition 30 accommodated in another chamber. Such a configuration may be realized using the above-described examples (example using an upper stage support unit) or the like.

Next, a semiconductor device of the embodiment in which a semiconductor element is encapsulated by compression molding the granular encapsulating resin composition will be described. First, a method of obtaining the semiconductor device by encapsulating the semiconductor element by compression molding using the granular encapsulating resin composition of the embodiment will be described.

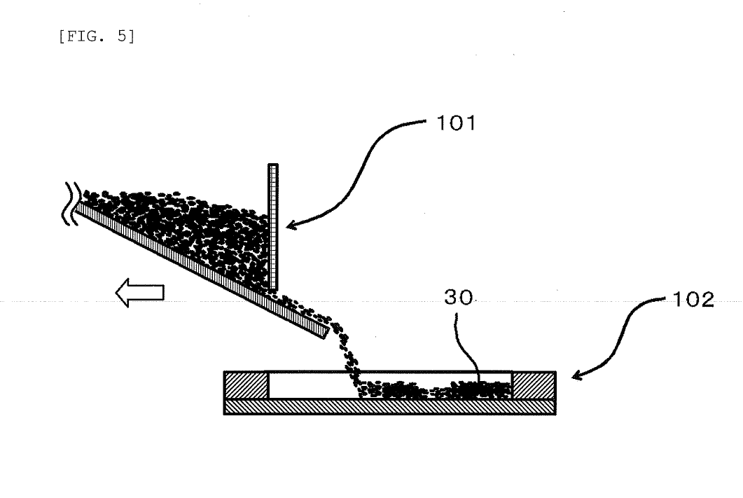

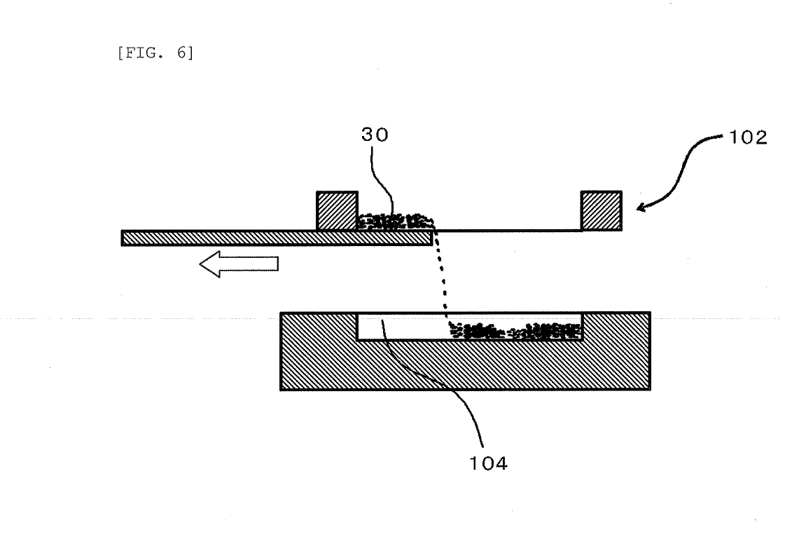

FIGS. 5 and 6 show schematic views of a method of weighing and supplying the granular encapsulating resin composition to a die cavity. A fixed amount of the granular encapsulating resin composition 30 is transported using a transport unit, such as a vibrating feeder 101, on a resin material supply vessel 102 including a resin material supply mechanism such as a shutter able to instantly supply the granular encapsulating resin composition 30 to a lower die cavity 104, and the resin material supply vessel 102 in which the granular encapsulating resin composition 30 is introduced is prepared (refer to FIG. 5). In this case, measuring of the granular encapsulating resin composition 30 in the resin material supply vessel 102 is able to be performed by a measuring unit placed below the resin material supply vessel 102. In the embodiment, there are numerous cases of the problem of agglomerates occurring due to significant consolidating arising in the main process. That is, when the state is one in which consolidation is easy, problems arise of agglomerates having already occurred when the resin composition is introduced to a molding device, lumpy agglomerates occurring during transport by the vibrating feeder 101 or the like and on the resin material supply vessel. Next, between the upper die and the lower die of the compression molding die, the resin material supply vessel 102 in which the granular encapsulating resin composition 30 is introduced is placed, and a lead frame or a circuit substrate to which the semiconductor element is mounted is fixed to the upper die of the compression molding die by a fixing unit such as a clamp or an adhesive so that the semiconductor element mounting surface is the lower side (not shown). In a case of the lead frame or circuit substrate having a structure with a hole, a backing is set on the surface of the opposite side to the semiconductor element mounting surface using a film or the like.

Next, when the weighed granular encapsulating resin composition 30 is supplied to inside the lower die cavity 104 (refer to FIG. 6) by a resin material supply mechanism, such as a shutter, that configures the bottom surface of the resin material supply vessel 102, the granular encapsulating resin composition 30 is melted at a predetermined temperature in the lower die cavity 104. Furthermore, after the resin material supply vessel 102 is transported to outside the die, mold clamping is performed by the compression molding device while the inside of the cavity is decompressed as necessary, the cavity is filled with the melted encapsulating resin composition so that the semiconductor element is enclosed, and the semiconductor element is encapsulated and molded by the granular encapsulating resin composition being further cured for a predetermined time. In this case, when agglomerates are present, heat circulation is uneven, and wire deformation in insufficiently melted parts increases. After the predetermined time elapses, the die is opened, and the semiconductor device is removed. Although degassing molding by decompressing the inside of the cavity is not essential, it is preferable in order to be able to reduce voids in the cured product of the granular encapsulating resin composition. A plurality of semiconductor elements may be mounted on the lead frame or circuit substrate, and these may be mounted by being stacked or arranged in rows.

Examples of the semiconductor element encapsulated in the semiconductor device of the embodiment include, but are not particularly limited to, integrated circuits, large scale integrations, transistors, thyristors, diodes, and solid-state imaging elements.

Examples of the semiconductor device of the embodiment include, but are not particularly limited to, a ball grid array (BGA), and a MAP-type BGA. In addition, a chip size package (CSP), a quad flat non-leaded package (QFN), a small outline non-leaded package (SON), a lead frame BGA (LF-BGA) or the like are also applicable.

The semiconductor device of the embodiment in which the semiconductor element is encapsulated with a cured product of the granular encapsulating resin composition by compression molding is mounted as is or after being completely cured at a temperature of 80° C. to approximately 200° C. for a time of 10 minutes to approximately 10 hours to an electronic device or the like.

Below, although detailed description of the semiconductor device including a lead frame or a circuit substrate, one or more semiconductor elements mounted by being stacked or arranged in rows on the lead frame or the circuit substrate, bonding wires that electrically connect the lead frame or the circuit substrate with the semiconductor element, a encapsulating material that encapsulates the semiconductor element and the bonding wires will be made using the drawings, the embodiment is not limited to using bonding wires.

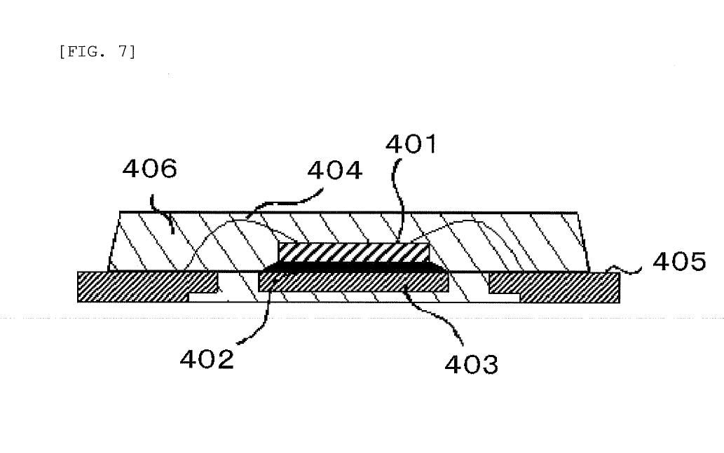

FIG. 7 is a diagram showing a cross-sectional structure of an example of a semiconductor device obtained by encapsulating a semiconductor element mounted on a lead frame using an encapsulating epoxy resin composition according to the embodiment. The semiconductor element 401 is fixed on a die pad 403 via a cured body of a die bonding material 402. An electrode pad and the lead frame 405 of the semiconductor element 401 are connected by a wire 404. The semiconductor element 401 is encapsulated by a encapsulating material 406 formed by a cured body of the epoxy resin composition of the embodiment.

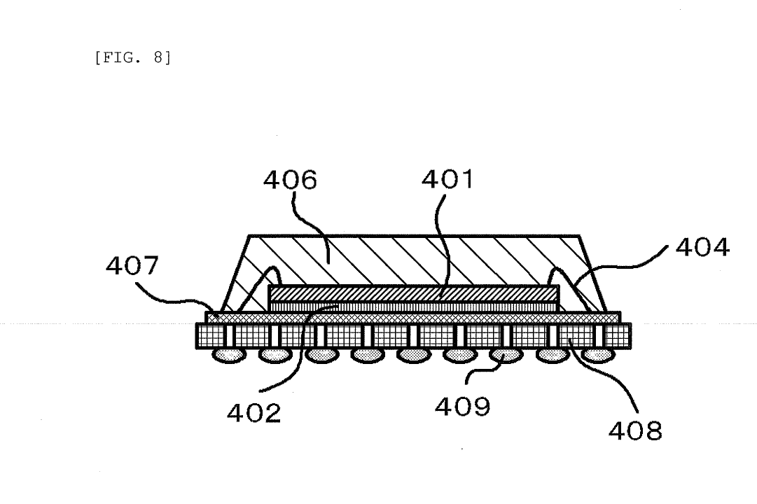

FIG. 8 is a diagram showing a cross-sectional structure of an example of a semiconductor device obtained by encapsulating a semiconductor element mounted on a circuit substrate using an epoxy resin composition according to the embodiment. The semiconductor element 401 is fixed on the circuit substrate 408 via a cured body of a die bonding material 402. The electrode pad of the semiconductor element 401 and the electrode pad on the circuit substrate 408 are connected by using a wire 404. Only one surface side of the semiconductor element 401 of the circuit substrate 408 is encapsulated by a encapsulating material 406 formed by a cured body of the epoxy resin composition of the embodiment. The electrode pad 407 on the circuit substrate 408 is bonded at the inner portions by solder balls 409 on the unsealed surface side on the circuit substrate 408.

The epoxy resin composition of the embodiment is able to encapsulate various devices, for example, transistors, thyristors, diodes, solid-state imaging elements, capacitors, resistors, LEDs or the like, without being limited to semiconductor elements such as integrated circuits and large scale integrations.

### Second Embodiment

The inventor conducted thorough research into preventing adhesion of the particles of the encapsulating epoxy resin to one another, and further discovered that the standard of the powder and granular material glass-transition temperature of the epoxy resin composition measured using modulated differential scanning calorimetry set in this way is effective as a design guide. Below, the embodiment will be described.

The powder and granular material glass-transition temperature of granular encapsulating resin composition according to the embodiment measured using modulated differential scanning calorimetry (MDSC) is equal to or more than 12° C. and equal to or less than 35° C. The powder and granular material glass-transition temperature is able to effectively control adhesion of the encapsulating epoxy resin composition particles to one another by being in this range.

The powder and granular material glass transition measured modulated differential scanning calorimetry is a standard showing the mutual adhesion prevention properties of the granular encapsulating resin composition particles. The modulated differential scanning calorimetry is a measuring method that raises the temperature by adding a sine wave-temperature modulation at the same time as a fixed speed of temperature rise. Therefore, different to differential scanning calorimetry of the related art, it is possible to measure the heat flow corresponding to the specific heat changes, and possible to more precisely evaluate the mutual adhesion prevention properties of the resin composition.

The powder and granular material glass-transition temperature measured using modulated differential scanning calorimetry is preferably equal to or more than 12° C. and equal to or less than 35° C., and more preferably equal to or less than 14° C. and equal to or less than 30° C. By the glass transition temperature being in this range, the mutual adhesion prevention properties of the granular encapsulating resin composition are greatly improved.

The powder and granular material glass-transition temperature measured using modulated differential scanning calorimetry, more specifically, may be measured as below. The powder and granular material glass-transition temperature is a value measured using modulated differential scanning calorimetry at 5° C./rain under atmospheric air flow, according to JISK 7121.

When the content of particles with a specified size in the encapsulating epoxy resin composition according to the embodiment in the particle size distribution measured by sieving with a JIS standard sieve is controlled, it is possible for the mutual adhesion prevention properties of the granular encapsulating resin composition to be further improved.

In the particle size distribution of the encapsulating epoxy resin composition measured by sieving using a 9 mesh JIS standard sieve, the content of particles with a particle size of equal to or more than 2 mm is preferably equal to or less than 3 mass % with respect to encapsulating epoxy resin composition according to the embodiment. By controlling to this range, it is possible for the mutual adhesion prevention properties to be further improved. The content of particles with a particle size of equal to or more than 2 mm is more preferably equal to or less than 1 mass %.

In the particle size distribution of the encapsulating epoxy resin composition measured by sieving using a 150 mesh JIS standard sieve, the content of fine powder with a particle size of less than 106 μm is preferably equal to or less than 5 mass % with respect to the encapsulating epoxy resin composition according to the embodiment. By controlling to this range, it is possible for the mutual adhesion prevention properties to be further improved. The content of fine powder with a particle size of less than 106 μm is more preferably equal to or less than 3 mass %.

### <Encapsulating Resin Composition 30>

The granular encapsulating resin composition of the embodiment includes (a) an epoxy resin, (b) a curing agent, and (c) an inorganic filler as essential components; however, (d) a curing accelerator, and (e) a coupling agent may be further included. Below, each component will be specifically described.

### [(a) Epoxy Resin]

The constitution of the epoxy resin other than the blending ratio may be the same as the first embodiment.

Although the lower limit value of the blending ratio of the overall epoxy resin is not particularly limited, equal to or more than 2 mass % in the entire resin composition is preferable, and equal to or more than 4 mass % is more preferable. When the lower limit value of the blending ratio is within the above range, there is little concern of a lowering or the like of the fluidity being caused. Although the upper limit value of the blending ratio of the overall epoxy resin is not particularly limited, equal to or less than 22 mass % in the entire resin composition is preferable, and equal to or less than 20 mass % is more preferable. When the upper limit value of the blending ratio is in this range, it is possible for the lowering of the powder and granular material glass-transition temperature to be reduced, and the mutual adhesion to be suitably controlled, and there is little concern of a lowering of the soldering resistance or the like being caused. In order for the meltability to be improved, it is desirable that the blending ratio be adjusted as appropriate according to the type of epoxy resin used.

### [(b) Curing Agent]

The constitution of the curing agent other than the blending ratio may be the same as the first embodiment.

Although the lower limit value of the blending ratio of the overall curing agent is not particularly limited, equal to or more than 2 mass % in the entire resin composition is preferable, and 3 mass % or more is more preferable. When the lower limit value of the blending ratio is within the above range, it is possible to obtain sufficient liquidity. In addition, although the upper limit value of the blending ratio of the overall curing agent is not particularly limited, equal to or less than 16 mass % in the entire resin composition is preferable, and equal to or less than 15 mass % is more preferable. When the upper limit value of the blending ratio is in this range, it is possible for the lowering of the powder and granular material glass-transition temperature to be reduced, and the mutual adhesion to be suitably controlled, and possible to obtain favorable soldering resistance. It is desirable that the blending ratio be appropriately adjusted according to the type of curing agent used in order for the meltability to be improved.

In a case in which a phenol resin based curing agent is used as the curing agent, as the compounding ratio of the overall epoxy resin and the overall phenol resin based curing agent, it is preferable that the equivalence ratio (EP)/(OH) of the number of epoxy groups (EP) of the overall epoxy resin and the number of phenolic hydroxyl groups (OH) of the overall phenol resin based curing agent be equal to or more than 0.8 and equal to or less than 1.3. When the equivalence ratio is in this range, it is possible to obtain sufficient curability during molding of the resin composition. When the equivalence ratio is in this range, it is possible to obtain favorable physical characteristics in the resin cured product. Taking a reduction of warpage in an area surface mounted-type semiconductor device into consideration, it is desirable to adjust the equivalence ratio (Ep/Ph) of the number of epoxy groups (Ep) of the overall epoxy resin and the number of phenolic hydroxyl groups (Ph) of the overall curing agent according to the type of curing accelerator used so as to be able to increase the curability of the resin composition, and the glass-transition temperature or the elastic modulus of the resin composition. In order for the meltability to be increased, it is desirable to appropriately adjust the equivalence ratio according to the type of epoxy resin and phenol resin based curing agent used.

### [(c) Inorganic Filler]

The constitution of the inorganic filler other than the blending ratio may be the same as the first embodiment,

As the lower limit value of the content ratio of the inorganic filler (c), equal to or more than 61 mass % is preferable with the overall encapsulating resin composition of the embodiment as a standard, and equal to or more than 65 mass % is more preferable. When the lower limit value of the content ratio of the inorganic filler is within the above range, it is possible for the lowering of the powder and granular material glass-transition temperature to be reduced, and the mutual adhesion to be suitably controlled, and it is possible to obtain satisfactory solder crack resistance without increasing the amount of moisture absorbed or lowering the strength as physical properties of the cured product of the resin composition. As the upper limit value of the content ratio of the inorganic filler, equal to or less than 95 mass % of the entire resin composition is preferable, equal to or less than 92 mass % is more preferable, and equal to or less than 90 mass % is particularly preferable. When the upper limit value of the content ratio of the inorganic filler is within the above range, it is possible to obtain favorable moldability without impeding the fluidity. In a range in which favorable soldering resistance is obtained, it is preferable that the content of the inorganic filler be set low.

In addition, when the content of the (a) epoxy resin, (b) curing agent and (c) inorganic filler is preferably (a) equal to or more than 2 mass % and equal to or less than 22 mass %, (b) equal to or more than 2 mass % and equal to or less than 16 mass %, and (c) equal to or more than 61 mass % and equal to or less than 95 mass % with respect to the total amount of the encapsulating epoxy resin composition, it is possible to suitably control the mutual adhesion in particular, and to obtain superior reliability, such as soldering resistance, and moldability. Although the relationship with mutual adhesion is unclear, it is thought that when the granular encapsulating resin composition is left alone and stored for a fixed period, although adjacent particles fuse to one another if slight plastic deformation occur in the resin components in the vicinity of the polar surface of the particles, when in the above ranges, it is more difficult for plastic deformation to occur.

### [(d) Curing Accelerator]

The constitution of the curing accelerator is the same as the first embodiment.

### [(e) Coupling Agent]

The constitution of the coupling agent is the same as the first embodiment.

### [Others]

In addition to the above components it is possible to blend as necessary coloring agents such as carbon black; mold releasing agents such as natural wax, synthetic wax, higher fatty acids or metallic salts thereof, paraffin, and polyethylene oxide; low stress agents such as silicone oil and silicone rubber; ion scavengers such as hydrotalcite; flame retardants, such as aluminum hydroxide; and various additives such as antioxidants in the granular encapsulating resin composition 30 of the embodiment.

The preparation method of the granular encapsulating resin composition 30, the configuration of the packaging material (inner packaging material 20 and/or outer packaging material 10), the packaging method, the encapsulating method of the semiconductor element in which the granular encapsulating resin composition 30 is used, and the configuration of the encapsulated semiconductor device are the same as the first embodiment.

According to the above-described first and second embodiments, the packaging material accommodated in the packaging material (inner packaging material 20 and/or outer packaging material 10) of the granular encapsulating resin composition 30, and the transport method that transports the granular encapsulating resin composition 30 in a state of being accommodated in the packaging material (inner packaging material 20 and/or outer packaging material 10) will be described.

Above, although embodiments of the invention have been described with reference to the drawings, these are examples of the invention, and various other configuration may be employed.

### EXAMPLES

Components used in the examples and comparative examples are shown below.

### (Epoxy Resin)

Epoxy resin 1: bipheylene skeleton-containing phenol-arakyl-type epoxy resin (NC 3000, manufactured by Nippon Kayaku Co. Ltd)

Epoxy resin 2: biphenyl epoxy resin (YX 4000H, manufactured by Japan Epoxy Resin Co. Ltd)

### (Phenol Resin)

Phenol resin 1: biphenylene skeleton-containing phenol-arakyl resin (MEH-7851SS, manufactured by Meiwa Plastic Industries)

Phenol resin 2: phenylene skeleton-containing phenol-arakyl resin (XLC-4L, manufactured by Mitsui Chemicals)

### (Inorganic Filler)

Spherical inorganic filler 1: spherical fused silica (average particle diameter 16 μm, specific surface area 2.1 m²/g)

Spherical inorganic filler 2: spherical fused silica (average particle diameter 10 μm, specific surface area 4.7 m²/g)

Spherical inorganic filler 3: spherical fused silica (average particle diameter 32 μm, specific surface area 1.5 m²/g)

The distribution of particle sizes in the spherical inorganic fillers 1 to 3 is shown in Table 1.

TABLE 1

| | Spherical Inorganic Filler (unit: mass %) | | |
|---|---|---|---|
| | Spherical | Spherical | Spherical |
| Particle Size | Inorganic | Inorganic | Inorganic |
| (μm) | Filler 1 | Filler 2 | Filler 3 |
| r ≦ 1 | 3 | 4 | 1 |
| r ≦ 2 | 9 | 11 | 8 |
| r ≦ 3 | 15 | 16 | 13 |
| 24 < r | 37 | 34 | 38 |
| 48 < r | 5 | 2 | 6 |

Fine spherical inorganic filler 1: spherical fused silica (average particle diameter 0.5 μm, specific surface area 6.1 m²/g)

Fine spherical inorganic filler 2: spherical fused silica (average particle diameter 1.5 μm, specific surface area 4.0 m²/g)

### (Other Components)

Curing accelerator 1: triphenylphosphine

Coupling agent: γ-glycidoxypropyltrimethoxysilane

Carbon Black

Wax: carnauba wax

### Example 1

After crushing and mixing of the raw materials of the epoxy resin composition with the blending shown in Table 2 for 5 minutes in a super mixer, the mixed raw materials were melted and kneaded at a screw rotation speed of 30 RPM, and a resin temperature 100° C. in a co-rotating twin-screw extruder having a cylinder bore with a diameter of 65 mm, next the melted and kneaded resin composition is supplied at a rate of 2 kg/hr from above a rotor with a 20 cm diameter, and the granular encapsulating resin composition 30 is obtained by being passed through a plurality of pores (hole diameter 2.5 mm) in the cylindrical outer peripheral portion heated to 115° C. by centrifugal force the obtained by the rotor being rotated at 3000 rpm. The characteristics of the resin composition of the granular encapsulating resin composition 30 are shown in Table 2.

Next, the obtained encapsulating resin composition 30 was stored and encapsulated in a cardboard case (outer packaging material 10) with a length and width of 32 cm and a height of 28 cm including eight chambers of upper and lower stages in total in the packaging method according to FIG. 4 including an upper stage support unit using plastic bags as the inner packaging material 20 so that the height of each inner packaging material 20 has the value shown in Table 2, and the cardboard case was closed with packing tape (the packaging method is referred to as A, and denoted similarly in Table 2.) After such packaging, the granular encapsulating resin composition was stored for one week in a refrigerator at −5° C. The height H of the inner packaging material in the example is measured in a state in which the packaged encapsulating resin composition contacts the upper surface of the inner packaging material, and in practice, the height H of the inner packaging material and the height L of the granular encapsulating resin composition may be taken as equivalent. Naturally, since the thickness of the inner packaging material is several hundred microns, there is an error of several millimeters in the height L of the granular encapsulating resin composition and the height H of the inner packaging material 20 in a case in which the thickness is taken into consideration. In the examples and the comparative examples below, inner packaging materials all with the same thickness were used, and measurement of the heights of the inner packaging materials 20 was performed in the same manner.

Thereafter, the granular encapsulating resin composition 30 was introduced at a predetermined position in a compression molding machine (PMC 1040, manufactured by Towa Japan) after being returned to room temperature for 3 hours in a 25° C. room without being opened; however, no agglomerates were found. Further, no agglomerates were found in the granular encapsulating resin composition 30 transported and dispersed on each of the vibrating feeder, on the resin material supply vessel, or on the die.

### Example 3

After crushing and mixing of the raw materials of the epoxy resin composition with the blending shown in Table 2 for 5 minutes in a super mixer, the mixed raw materials were melted and kneaded at a screw rotation speed of 30 RPM, and a resin temperature 100° C. in a co-rotating twin-screw extruder having a cylinder bore with a diameter of 65 mm, and a particulate encapsulating resin composition 30 was obtained by removing the coarse particles and the fine powder using a sieve from a crushed product obtained through cooling and crushing processes. The characteristics of the granular encapsulating resin composition 30 are shown in Table 2.

Next, the obtained encapsulating resin composition 30 was stored and encapsulated in a cardboard case (outer packaging material 10) with a length and width of 32 cm and a height of 20 cm including 4 chambers in the packaging method according to FIG. 2 using plastic bags as the inner packaging material 20 so that the height of each inner packaging material 20 has the value shown in Table 2, and the cardboard case was closed with packing tape (the packaging method of the example is referred to as B, and denoted similarly in Table 2.) After such packaging, the granular encapsulating resin composition was stored for one week in a refrigerator at −5° C.

Thereafter, the granular encapsulating resin composition 30 was introduced at a predetermined position in a compression molding machine (PMC 1040, manufactured by Towa Japan) after being returned to room temperature for 3 hours in a 25° C. room without being opened; however, no agglomerates were found. No agglomerates were found in the granular encapsulating resin composition 30 transported and dispersed on each of the vibrating feeder, on the resin material supply vessel, or on the die.

### Examples 2 and 4

Although the granular encapsulating resin composition 30 was obtained similarly to Example 1 with the blending shown in Table 2, and was stored and molded similarly to Example 1 in packaging method A (wherein the height of the inner packaging material is shown in Table 2), no agglomerates were discovered.

### Comparative Examples 1 to 4

The granular encapsulating resin composition of Comparative Examples 1, 2 and 4 was obtained similarly to Example 1, and the granular encapsulating resin composition of Comparative Example 3 was obtained similarly to Example 3, with the blending shown in Table 2.

Next, after the granular encapsulating resin composition obtained as above was stored in the plastic bags, the plastic bags were stored and encapsulated in a cardboard case with a length and width of 32 cm and a height of 35 cm the inner portion of which is divided into four chambers similarly to FIG. 2 so that the height of each plastic bag has the value shown in Table 2 (packaging method of the Comparative Example is referred to as C, and denoted similarly in Table 2), and storage and molding were performed similarly to Example 1. As a result, some agglomerates were discovered during introduction to the molding machine or during transport and weighing.

TABLE 2

| | | | | | | Comparative | Comparative | Comparative | Comparative |
|---|---|---|---|---|---|---|---|---|---|
| | | Example 1 | Example 2 | Example 3 | Example 4 | Example 1 | Example 2 | Example 3 | Example 4 |
| Epoxy Resin 1 | | 5.3 | 5.3 | | 19.5 | 5.3 | 5.3 | | 19.5 |
| Epoxy Resin 2 | | | | 4.7 | | | | 4.7 | |
| Phenol Resin 1 | | 3.9 | 3.9 | | 14.4 | 3.9 | 3.9 | | 14.4 |
| Phenol Resin 2 | | | | 4.5 | | | | 4.5 | |
| Spherical | | | | 75.0 | 55.0 | | | 75.0 | 55.0 |
| Inorganic Filler 1 | | | | | | | | | |
| (D50: 16 SSA: 2.1) | | | | | | | | | |
| Spherical | | 70.0 | | | | 70.0 | | | |
| Inorganic Filler 2 | | | | | | | | | |
| (D50: 10 SSA: 4.7) | | | | | | | | | |
| Spherical | | | 80.0 | | | | 80.0 | | |
| Inorganic Filler 3 | | | | | | | | | |
| (D50: 32 SSA: 1.5) | | | | | | | | | |
| Microspherical | | 10.0 | 5.0 | 7.5 | 5.0 | 10.0 | 5.0 | 7.5 | 5.0 |
| Inorganic Filler 1 | | | | | | | | | |
| (D50: 0.5 SSA: 6.1) | | | | | | | | | |
| Microspherical | | 10.0 | 5.0 | 7.5 | 5.0 | 10.0 | 5.0 | 7.5 | 5.0 |
| Inorganic Filler 2 | | | | | | | | | |
| (D50: 1.5 SSA: 4.0) | | | | | | | | | |
| Curing | | 0.1 | 0.1 | 0.1 | 0.4 | 0.1 | 0.1 | 0.1 | 0.4 |
| Accelerator 1 | | | | | | | | | |
| Coupling Agent | | 0.2 | 0.2 | 0.2 | 0.2 | 0.2 | 0.2 | 0.2 | 0.2 |
| Carbon Black | | 0.3 | 0.3 | 0.3 | 0.3 | 0.3 | 0.3 | 0.3 | 0.3 |
| Wax | | 0.2 | 0.2 | 0.2 | 0.2 | 0.2 | 0.2 | 0.2 | 0.2 |
| Filler Mass % | % | 90.0 | 90.0 | 90.0 | 65.0 | 90.0 | 90.0 | 90.0 | 65.0 |
| Preparation | | Centrifugal | Centrifugal | Sieving | Centrifugal | Centrifugal | Centrifugal | Sieving | Centrifugal |
| Method | | Milling | Milling | | Milling | Milling | Milling | | Milling |
| Nature of Resin | | | | | | | | | |
| Composition | | | | | | | | | |
| Coarse Particles | Mass % | 0.3 | 0.8 | 0.2 | 0.3 | 0.3 | 0.8 | 0.2 | 0.3 |
| of 2 mm or higher | | | | | | | | | |
| Fine Powder of | Mass % | 1.3 | 2.2 | 0.5 | 0.7 | 1.3 | 2.2 | 0.5 | 0.7 |
| less than 106 μm | | | | | | | | | |
| Absolute Specific | (g/cc) | 1.99 | 1.98 | 1.99 | 1.70 | 1.99 | 1.98 | 1.99 | 1.70 |
| Gravity | | | | | | | | | |
| Bulk Density M | (g/cc) | 0.85 | 0.86 | 0.85 | 0.69 | 0.85 | 0.86 | 0.85 | 0.69 |
| Height H of Inner | cm | 13 | 12 | 19 | 11 | 30 | 26 | 27 | 33 |
| Packaging Material | | | | | | | | | |
| M*H | | 11.05 | 10.32 | 16.15 | 7.59 | 25.5 | 22.36 | 22.95 | 22.77 |
| Spiral Flow | cm | 189 | 126 | 203 | 235 | 189 | 126 | 203 | 235 |
| Encapsulating | ° C. | 26 | 16 | 18 | 19 | 26 | 16 | 18 | 19 |
| Resin Composition | | | | | | | | | |
| Tg using MDSC | | | | | | | | | |
| Packaging Method [symbol] | | A | A | B | A | C | C | C | C |
| Agglomerate | | None | None | None | None | Present | Present | Present | Present |
| Amount of Wire | % | 1.5 | 2.7 | 2 | 0.9 | 7.9 | 9.2 | 8.8 | 7.1 |
| Deformation | | | | | | | | | |

[symbol]

indicates data missing or illegible when filed

### <Evaluation Method>

The particulate encapsulating resin composition in the examples and the comparative examples was evaluated with the following method.

### 1. Specific Surface Area (SSA)

Evaluation was performed using a MACSORB HM MODEL-1201, manufactured by Mountech, Co., Ltd. by a BET fluid method.

### 2. Average Particle Diameter (D₅₀)

Evaluation was performed using a SALD-7000 manufactured by Shimadzu Corporation by a laser diffraction particle size distribution measurement method. D₅₀ is the median diameter.

3. Amount of Fine Powder of Less than 106 μm and Amount of Coarse Particles of 2 Mm or More

Determination was performed using JIS standard sieves with opening sizes of 2.00 mm and 0.106 mm attached to a low-tap shaker. The weight of particles and grains remaining on each sieve was measured after 40 g sample was passed through the sieves while the sieves were shaken over 20 minutes and classified. The weight ratio of the amount of fine powder with a particle size of less than 106 μm and the amount of coarse particles of equal to or more than 2 mm was calculated based on the weight measured in this way and the weight of the sample before classification.

### 4. Absolute Specific Gravity

The obtained encapsulating resin composition was temporarily compressed into tablets of predetermined dimensions, formed into disks with a diameter of 50 mm and a thickness of 3 mm using a transfer molding machine at a die temperature 175±5° C., an injection pressure of 7 MPa and curing time of 120 seconds, and the mass and the volume were obtained and the specific gravity of cured product was measured.

### 5. Bulk Specific Gravity

Using a powder tester (manufactured by Hosokawa Micron), after a sample of the granular encapsulating resin composition was slowly placed in a measuring vessel with an inner radius of 50.46 mm, a depth of 50 mm and a volume of 100 cm³ with a cylinder attached to the upper portion, tapping was performed 180 times, and thereafter, the upper cylinder was removed, the sample deposited on the upper portion of the measuring vessel was leveled with a blade, and the weight of the sample charged to the measuring vessel was measured.

### 6. Spiral Flow

Using a low pressure transfer molding machine (“KTS-15”, manufactured by Kohtaki Precision Machine Co., Ltd.), the granular encapsulating resin composition of each example and each comparative example was injected in conditions of 175° C., injection pressure 6.9 MPa, and pressure dwell 120 seconds to a spiral flow measurement die according to ANSI/ASTM D 3123-72, the flow length was measured, and this was set as the spiral flow (cm).

### 7. Encapsulating Resin Composition Glass-Transition Temperature (Tg) by MDSC

The granular encapsulating resin composition of the invention (before curing) is measured at 5° C./rain at atmospheric pressure using modulated differential scanning calorimetry (below, denoted as a modulated DSC or MDSC) and a value is obtained according to JISK 7121.

### 8. Wire Deformation

A 9 mm square semiconductor element with a thickness of 0.3 mm was adhered with silver paste on a circuit substrate with a thickness of 0.5 mm, width of 50 mm and length of 210 mm, gold wires with a diameter of 25 μm, and a length of approximately 5 mm were bonded to the semiconductor element and the circuit substrate at intervals with a pitch of 60 μm, the resulting product was collectively encapsulated and molded with a compression molding machine (PMC 1040, manufactured by TOWA Japan), thus obtaining a MAP molded article. The molding conditions at this time were a die temperature of 175° C., a mold pressure of 3.9 MPa, and a curing time of 120 seconds. Next, the obtained MAP molded article was divided into individual pieces by dicing, and simulated semiconductor devices were obtained. The amount of wire sweep in the obtained simulated semiconductor devices was measured as the average flow rate of the four longest gold wires (length 5 mm) on the diagonals of the package using a soft X-ray device (PRO-TEST-100, manufactured by Softex Co., Ltd.), and the wire sweep rate (wire sweep amount/wire length×100(%)) was calculated.

The evaluation results are shown in Table 2.

In the examples, no agglomerates were present in the granular encapsulating resin composition, and the wired deformation amount was low. On the other hand, in the granular encapsulating resin composition of the comparative examples, when introduced to the molding machine, agglomerates occur occasionally, the agglomerates do not sufficiently melt on the die, and the wire deformation amount increases.

The inventor confirmed similar results as Examples 1 to 4 in a case in which the granular encapsulating resin composition 30 with a bulk density M of equal to or more than 1.0 g/cc and equal to or less than 1.3 g/cc was packaged in conditions in which H was equal to or less than 14.6 cm with the same method as Examples 1 to 4.

This application claims priority based on Japanese Patent Application 2012-44268 filed on Feb. 29, 2012, the entire disclosure of which is incorporated herein.

1. A method of packaging a granular encapsulating resin composition,
wherein, when a bulk density of the granular encapsulating resin composition is set to M (g/cc) and
a height of deposited material of the granular encapsulating resin composition is L (cm) in a state of being accommodated in a packaging material,
the method satisfies the relationship M×L≦19.

2. The method of packaging the granular encapsulating resin composition according to claim 1,
wherein the packaging material includes an inner packaging material in which the granular encapsulating resin composition is directly accommodated, and
an outer packaging material having one or a plurality of chambers in an inner portion thereof in which the inner packaging material is accommodated, and
wherein, when a height of one inner packaging material is H (cm) in a state of being accommodated in the outer packaging material,
the method satisfies the relationship M×H≦19.

3. The method of packaging the granular encapsulating resin composition according to claim 2,
wherein M is equal to or more than 0.70 (g/cc) and equal to or less than 0.95 (g/cc), and H is equal to or less than 20 cm.

4. The method of packaging the granular encapsulating resin composition according to claim 2,
wherein M is equal to or more than 1.0 (g/cc) and equal to or less than 1.3 (g/cc), and H is equal to or less than 14.6 cm.

5. The method of packaging the granular encapsulating resin composition according to claim 1,
wherein the packaging material includes an outer packaging material having one or a plurality of chambers in an inner portion thereof in which the granular encapsulating resin composition is directly accommodated, and
wherein, when a height of the chamber is N (cm) in a state of a bottom surface of the outer packaging material being placed on a ground surface,
the method satisfies the relationship M×N≦19.

6. The method of packaging the granular encapsulating resin composition according to claim 5,
wherein M is equal to or more than 0.70 (g/cc) and equal to or less than 0.95 (g/cc), and N is equal to or less than 20 cm.

7. The method of packaging the granular encapsulating resin composition according to claim 5,
wherein M is equal to or more than 1.0 (g/cc) and equal to or less than 1.3 (g/cc), and N is equal to or less than 14.6 cm.

8. The method of packaging the granular encapsulating resin composition according to claim 6,
wherein the outer packaging material has a plurality of outer surfaces, and even if any of the outer surfaces is placed on the ground surface as the bottom surface, N is equal to or less than 20 cm.

9. The method of packaging the granular encapsulating resin composition according to claim 7,
wherein the outer packaging material has a plurality of outer surfaces, and even if any of the outer surfaces is placed on the ground surface as the bottom surface, N is equal to or less than 14.6 cm.

10. The method of packaging the granular encapsulating resin composition according to claim 2,
wherein the inner portion of the outer packaging material is divided into the plurality of chambers of a multi-stage configuration.

11. The method of packaging the granular encapsulating resin composition according to claim 10,
wherein the inner portion of the outer packaging material is divided such that a weight of the granular encapsulating resin composition accommodated in a given chamber is not applied to the granular encapsulating resin composition accommodated in another chamber.

12. The method of packaging the granular encapsulating resin composition according to claim 1,
wherein the granular encapsulating resin composition includes an inorganic filler.

13. The method of packaging the granular encapsulating resin composition according to claim 12, wherein the inorganic filler is silica.

14. The method of packaging the granular encapsulating resin composition according to claim 1,
wherein the granular encapsulating resin composition includes an epoxy resin.

15. The method of packaging the granular encapsulating resin composition according to claim 1,
wherein the granular encapsulating resin composition includes a phenol resin.

16. The method of packaging the granular encapsulating resin composition according to claim 1,
wherein the granular encapsulating resin composition is a granular encapsulating epoxy resin composition used for encapsulating elements by compression molding comprising:
(a) an epoxy resin,
(b) a curing agent, and
(c) an inorganic filler as essential components,
wherein a powder and granular material glass-transition temperature of the encapsulating epoxy resin composition measured using modulated differential scanning calorimetry is equal to or more than 12° C. and equal to or less than 35° C.

17. The method of packaging the granular encapsulating resin composition according to claim 16,
wherein the content of particles with a particle size of equal to or more than 2 mm in the granular encapsulating epoxy resin composition is equal to or less than 3 mass % with respect to a total amount of the encapsulating epoxy resin composition.

18. The method of packaging the granular encapsulating resin composition according to claim 16,
wherein the content of particles with a particle size of less than 106 μm in the granular encapsulating epoxy resin composition is equal to or less than 5 mass % with respect to a total amount of the encapsulating epoxy resin composition.

19. The method of packaging the granular encapsulating resin composition according to claim 16,
wherein the content of (a) the epoxy resin, (b) the curing agent, and (c) the inorganic filler is (a) equal to or more than 2 mass % and equal to or less than 22 mass %, (b) equal to or more than 2 mass % and equal to or less than 16 mass %, and (c) equal to or more than 61 mass % and equal to or less than 95 mass % with respect to the total amount of the encapsulating epoxy resin composition.

20. The method of packaging the granular encapsulating resin composition according to claim 16,
wherein (b) the curing agent is a phenol resin.

21. The method of packaging the granular encapsulating resin composition according to claim 16, further comprising:
(d) a curing accelerator,
wherein (d) the curing accelerator is a compound containing phosphorus atoms selected from a group consisting of adducts of a tetra-substituted phosphonium compound, a phosphobetaine compound, a phosphine compound, and a quinone compound and adducts of a phosphonium compound and a silane compound.

22. The method of packaging the granular encapsulating resin composition according to claim 16, further comprising:
(e) a coupling agent
wherein the coupling agent is a silane coupling agent having a secondary amino group.

23. The method of packaging the granular encapsulating resin composition according to claim 16,
wherein the element is a semiconductor element.

24. A package comprising:
a packaging material; and
a granular encapsulating resin composition with a bulk density of M (g/cc) that is accommodated in the packaging material,
wherein, when a height of deposited material of the granular encapsulating resin composition is L (cm) in a state of being accommodated in the packaging material,
the relationship M×L≦19 is satisfied.

25. A method of transporting a granular encapsulating resin composition in a state of being accommodated in a packaging material,
wherein, when a bulk density of the granular encapsulating resin composition is set to M (g/cc) and
a height of deposited material of the granular encapsulating resin composition is L (cm) in a state of being accommodated in the packaging material,
the method satisfies the relationship M×L≦19.
